(19) United States
(12) Patent Application Publication
(10) Pub. No.: US 2024/0108051 A1
(43) Pub. Date: Apr. 4, 2024

(54) IMPROVEMENTS IN AND RELATING TO SINGULARISING CLUSTERED FRUIT

(71) Applicant: BBC Technologies Limited, Hamilton (NZ)

(72) Inventor: Geoffrey Furniss, Cambridge (NZ)

(21) Appl. No.: 18/272,942

(22) PCT Filed: Jan. 21, 2022
(86) PCT No.: PCT/IB2022/050510

§ 371 Date: Jul. 18, 2023

(30) Foreign Application Priority Data
Jan. 21, 2021 (NZ) 772197

(51) Int. Cl. A23N 15/02; B65G 51/01

(52) U.S. Cl. CPC A23N 15/02; B65G 51/01; A23N 2015/006; B65G 2201/0211

(57) ABSTRACT

This invention relates to improvements in and relating to apparatus for singularising clustered fruit and to the methods of manufacturing and using the apparatus. In particular, the apparatus and the methods of manufacturing and using the apparatus are directed to singularise fruit from a cluster by separation at the stem knuckle or join of the cluster, to effect single fruit retaining a quality stem and having desired qualities and presentation properties, without damaging the fruit, as required for and/or dictated by the target market, where the market is comprised of the local consuming public and/or broader commercial and/or business enterprises whether domestic and/or overseas. The invention will be applicable to fruits which demonstrate the propensity for clustering, such as cherries, although the invention can be and may be adapted for use in singularising other clustered fruits, such as tomatoes, beans, peas, plums, and so forth.

### TECHNICAL FIELD

This invention relates to improvements in and relating to apparatus for singularising clustered fruit and to the methods of manufacturing and using the apparatus.

In particular, the apparatus and the methods of manufacturing and using the apparatus are designed to substantially improve the ability to effectively singularise fruit from a cluster without damaging the fruit and preferably the apparatus enables the clustered fruit to be separated at the stem knuckle or join, such that the singularisation process effects a single fruit having desired qualities and presentation properties required for and/or dictated by the target market, where the market is comprised of the local consuming public and/or broader commercial and/or business enterprises whether domestic and/or overseas.

The invention will be applicable to fruits which demonstrate the propensity for clustering, such as cherries.

However, while the present description is provided with reference to singularising clustered cherries, the invention can be and may be adapted for use in singularising other clustered fruits, such as tomatoes, beans, peas, plums, and so forth.

### BACKGROUND ART

The traits of clustered fruits, including cluster compactness, fruit maturity, and fruit number per cluster, are important to breeders and producers. The bigger the crop and/or the better the quality of the fruit, the better the returns available to the plant breeders and fruit producers become.

However, the market has demonstrated a demand for some clustered fruits to be singularised, yet retain a fruit stem having preferred attributes and/or qualities.

Clustered fruit in the context of the present invention includes cherries. However, the invention also has application for other fruits that similarly result in clusters of the fruit that might, or do, require separation from a cluster. Accordingly, it is well known that a number of systems exist for singularising clustered fruit that have been designed and operate to meet the market demand for the relevant fruit products and to take advantage of premium prices for the relevant fruit crops.

Within the prior art there are a number of systems and/or apparata applied to/used with fruit products that are joined to each other through connecting ‘appendages’, such as petioles, stems, stalks, and so forth. In some of the prior art, such apparata and methods are used for cherries, small clusters of cherry tomatoes, beans, and so forth, that have been previously picked and that normally arrive at a processing or packaging facility joined in small bunches or that are still connected to each other through the relative stems, as in the case of clustered cherries.

Often the fruit is loaded into the said apparatus via a conveyor belt system, such that multiple fruit clusters may be placed on top of each other. This frequently negates or impedes clean singularising of the clustered fruit, or results in damaged fruit, singularised fruit in which the stems are irregularly cut, or fruit in which the stems are completely removed.

In yet other systems, the cutting means of the apparata may included upwardly facing blades within the bed of the apparata, or downwardly facing blades suspended in an arrangement above the fruit, whether said blades are elongate blades or rotating blades. Given the softness of the flesh of fruits generally, such blades may not only cut through the stems, but may also cause damage to the fruit, particularly where the fruit is inappropriately aligned/orientated; or, the stems may be irregularly cut

Alternatively, or additionally, some systems may employ conveying systems where the bed of the conveying system on which the fruit is placed may be such that as the fruit is conveyed, the fruit surface may be in contact with the bed of the conveying system and be subjected to damage simply by virtue of the frictional contact between the fruit skin and the conveyor bed. In yet other systems, the fruit may be loaded on to vibrating surfaces—on which the fruit clusters are placed and transported to a location where the clusters are to be cut. However, such vibrations may similarly cause the fruit to be rubbed against the surface and/or against other adjacently located fruit, which may again damage the fruit.

Yet other systems may rely on centrifugal forces—either where the force of water is to separate the clustered fruit; or, dry centrifugal forces are employed within systems whereby the stems of the cherries are gripped and the centrifugal forces are used to tear the stems of the cluster apart. In both systems the very force used to separate the stems of the fruit may result in damage to the fruit.

While the above discussion is not an exhaustive consideration of the prior art, it may be appreciated that existing systems may have, or do have, limitations. In a marketplace where quality and quantity are primary considerations, it is reasonable that any system designed for, and used in, separating clustered fruit, might rather focus on employing methods and apparata that not only facilitate the singularising of the clustered fruit, but wherever possible do so in a manner that may not only maximize the quantity, but also maximize the quality of the singularised fruit.

Accordingly, in relation to the present invention, where separation is preferred, the benefits of the invention are, therefore, directed to better:
Meet market demands for declustered fruit; and/or
Meet market demands for fruit bearing intact stalks; and/or
Minimise the losses that flow from fruits which lack stalks or have hooked or only partial stalks.
Enable fruit that is within a cluster, but damaged, to be effectively and easily separated from the good (marketable) fruit during subsequent quality control and packing processes; and/or
Effect a greater likelihood of ensuring correct slicing through the joining point/abscission zone/knuckle of the clustered fruit to neatly separate adjacent fruit within each single cluster, and/or
Effect quality of the separated fruit to meet consumer demand; and/or
Meet commercial demands for single fruits bearing an intact stalk of preferred quality.

It was in regard to the above, that the present apparatus and method were invented.

It was also developed having regard to supporting the desired/required quality control processing associated with such systems, that the present invention was developed.

Finally, it was having regard to the need to provide a system that could be applied to a range of fruits, that the present invention was developed.

It would be further useful, therefore, to also have a process and for manufacturing a means for singularising clustered fruit that:
1. Would be cost effective;
2. Would be able to be incorporated into new or existing systems for grading and packing fruits; and
3. Would be compact; and
4. Would be easily moved from one location to another, and 5. Would be relatively easy to clean and/or maintain; and
6. Could avoid unnecessary losses due to damaged and/or unwanted fruit; and
7. Would require minimal effort to operate; and
8. May be faster to use than existing systems; and
9. Would require minimal maintenance, such as simply sharpening, or replacing possible cutting means; and
10. Could be adapted to be used for a variety of fruits, in a range of applications; and
11. Would able to be made in a variety of ways to suit many different fruit processing, grading and packing systems.

It would therefore be advantageous to have an invention that offered at least some, if not all, of the potential advantages of the above proposed apparatus and method for singularising clustered fruits. It is, therefore, an object of the present invention to consider the above problems and market demands and provide at least one solution which addresses a plurality of these problems/demands.

It is another object of the present invention to at least provide the public with a useful choice or an alternative system.

Further aspects and advantages of the present invention will become apparent from the ensuing description which is given by way of example only. It should also be appreciated that variations to described embodiments are possible and would fall within the scope of the present invention.

It is, therefore, a further object of the present invention that whilst the apparatus and method for singularising clustered fruit is described with reference to cherries, the apparatus and method may be relevant to or adapted for use with and in a number of other applications and fruits.

### DISCLOSURE OF INVENTION

The present invention is directed to improved apparatus for use in singularising/declustering clustered fruit. The present invention is further directed to the use and operation of the apparatus for ensuring the singularised fruit meets market requirements, specifications and demands for preferred presentation and appearance of fruit for wholesale, retail and commercial purposes.

The present invention is further directed to the manufacture of the apparatus for use in singularising clustered items, such as fruit.

For the purpose of the present invention, the term ‘declustering’ shall mean and include any apparatus, method and/or technique that facilitates the singularising of individual fruits from a larger fruit cluster. Declustering methods may include manual declustering. However, for the purpose of the present invention, the term ‘declustering’ shall be relevant to the use of apparatus designed to achieve declustering and the techniques and methods applied via automated systems to achieve same.

For the purpose of the present invention, the terms ‘singularising/singularisation’ shall mean, define and include any apparatus, method and/or technique used in the process of declustering, in order to effect separation of clustered items, resulting in intact, single, individual, stand-alone items separated from/derived from the clustered group, such that each singled item is set apart from all other separated items derived from an original cluster. For the purpose of the present invention, the terms ‘declustering’ and ‘singularising’ shall be used alone or together in reference to the separation of fruit that typically grows in clusters of two or more individual fruits. Certain fruiting plants/trees display a propensity for producing multiple inflorescence buds that are clustered together, such that the resultant individual fruits are also clustered together (in some instances in a cluster of up to five or more).

It should, however, be appreciated that either or both the terms ‘declustering’ and/or ‘singularising’ are not intended to limit the scope of the present invention.

In addition, for the purpose of the present invention, the term “fruit”, shall broadly mean and include the part of a plant which develops from the flower of the plant and is characterised as the sweet and fleshy product that contains seed and may be eaten as food. Some fruits may also be classified, botanically, as a berry.

The present invention applies to all such fruits, particularly where said fruits are characterised by growing in clusters and are able to be separated therefrom to result in individual fruit. Therefore, it should be appreciated that the term ‘fruit’ is not intended to limit the scope of the present invention to only one type of fruit, nor does the use of the term ‘fruit’ exclude any that may be specifically classified as a ‘berry’.

In relation to the present invention, the following description will, however, be provided with reference to cherries. The use of cherries to example the current invention should nevertheless not be seen as limiting the scope of the invention. Rather, the present invention may also be used for, or adapted for use with, a range of other fruits that typically grow in clusters and particularly where it is advantageous for the clustered fruit to be separated individually and preferably retain all or a preferred portion of the fruit stem.

The ‘Cherry’ includes any of various trees belonging to the genus Prunus and that has edible fruits. Commercial production includes sour cherries (Prunus cerasus), which are often frozen or canned and used in sauces and pastries; and, sweet cherries (P. avium), which are usually consumed fresh and are also the principal type preserved in true or imitation maraschino liqueur.

When considering the production of fruit (and particularly fruit from trees), there are spurs which are short, stubby, side stems that arise from a main stem. These spurs are the fruit-bearing stems on trees including (but not limited to) fruit trees such as pear, apple, and cherry trees (but not limited to only these examples). From these spurs, the inflorescence buds (or flowers) emerge and the fruit then develops from the fertilised ovaries of the flowers of the plant/tree.

When considering a seasonal, but profitable, fruit crop such as cherries (including both sweet and sour cherries) the inflorescence buds are typically in clusters of two to four (or in some instances even up to five or more).

Each individual flower within an inflorescence has a long pedicel (stalk) bearing the flower which, when fertilisation occurs, results in a fruit (cherry) located at the end of the stalk, but often within a resulting connected cluster of two or more cherries.

In relation to fruit generally and cherries specifically, where the demand is for fruit with stems intact, cherries borne singly on a spur may be harvested differently from those in clusters. However, the challenge is getting the cherry to separate at the upper abscission zone at the twig, with its stem intact.

Where there is a cluster of cherries, the cluster as a whole may also separate at the upper abscission zone at the twig. However, the challenge then is to separate the clustered cherries so that they can be presented singularly from the cluster. Further, the challenge is then to ensure that each individual stem is retained whole and has the characteristics preferred and/or required by the market for individual fruits with stems on.

In the complex world of supply and demand, it is not unusual for the market to require that a product has, or displays, particular qualities. As such, the market may specifically demand/call for/require fruits with stems/stalks on. This requirement may be simply motivated by aesthetics. However, in return, the market may be willing to pay up to several times more than the normal processing price to get them.

Alternately, or in addition to the above requirement, it is often beneficial with some fruits to leave the fruit stems/stalks intact and in place. This is particularly beneficial where to do so assists in maintaining the freshness of the fruit for longer. A requirement based on this outcome may therefore be motivated by a desire for a preferred quality of product.

The longer the fruit remains fresh, the longer the fruit remains fresh during sorting, packaging, transport and after delivery to retail, wholesale, or commercial outlets—where the fruit is available to be sold or processed. This requirement may be simply motivated by the desire to have the product retain its qualities and remain fresh over a longer selling or processing period. However, again, in return, the market may be willing to pay up to several times more for the benefit of having a product with desirable longevity and/or a longer product saleability period.

The current invention seeks to offer and effect the singularising of clustered fruit to meet market demands for either or both fruits with stems/stalks on and fruits having longevity and/or a longer period of product saleability.

Therefore, according to one aspect of the present invention there is provided an apparatus for singularising clustered fruits, said apparatus effecting separation of the clustered fruits from one another at their joining point/knuckle/abscission zone.

In relation to the present invention, for some fruits (such as the cherry), there may be up to two abscission zones. One may typically exist between the peduncle and pedicel and the other between the pedicel and the fruit. A pedicel is the stalk of an individual flower or fruit within a cluster, while a peduncle is the stalk supporting an inflorescence (a cluster of flowers that results in a corresponding cluster of fruit). When the abscission zone is at the pedicle, the fruit drops off without a stalk. When the abscission zone is at the peduncle (which is at the point where the clustered fruits are connected), the cluster is able to be removed as a whole, with each individual fruit stalk (pedicle) being intact and hence the individual fruit is retained at the end of its own stalk, but within a cluster.

Therefore, for the purpose of the present invention the terms ‘knuckle’, ‘joining point’ and/or ‘abscission zone’ shall mean and refer to the region of the peduncle (which is at the joint or joining point) where the clustered fruits are connected to the branch of the tree/plant, and which is adapted to enable separation of a fruit cluster (at that point) from the rest of the plant body. In relation to the current description, the abscission zone shall therefore mean and refer to the region of the fruit stalk that breaks off from the stem of the plant and allows the fruit to fall off intact—and in relation to the present invention shall mean that each fruit retains its stalk once the stalk and fruit separate from the plant. The terms ‘knuckle’, ‘joining point’ and/or ‘abscission zone’ may be referred to singularly or collectively throughout the description. However, all of these terms relate to the point at which a cluster of fruits is connected. Therefore, use of any or all of these terms is not intended to limit the scope of the present invention.

It should be appreciated that in regards to sweet cherries, the fruit clusters do not typically fall off the tree. Rather, they are tom off or ‘picked off’. Some varieties may fall off, especially when over-mature, but they will often leave the stem on the tree. Accordingly, it is preferable that the clusters of fruit be picked before the individual fruits become over ripened.

According to another aspect of the present invention, the apparatus for singularising clustered fruit includes at least one channel for the linear processing of said fruit; said channel including a base and side portions.

According to another aspect of the present invention, the base of the channel is adapted to facilitate directional movement of the clustered fruit and/or unclustered (singularised) fruit along the length of the channel.

It should be appreciated that not only will fruit be directed into the channel, but also there is the potential for assorted debris such as leaves and sticks, resulting from harvesting, to be directed in to the channel.

According to another aspect of the present invention, the apparatus for singularising clustered fruit, wherein the channel further optionally includes a bed.

According to another aspect of the present invention, the apparatus for singularising clustered fruit, wherein the bed may be separate from and/or distanced above the base.

According to another aspect of the present invention said base and/or said bed includes cutting means, for singularising individual fruit from the said fruit cluster.

According to another aspect of the present invention the said cutting means are located above the lowest point of either or both the base and the bed of the channel.

According to another aspect of the present invention, either or both the base and the bed of the channel are configured to progress the clustered fruit and/or the unclustered fruit along the channel at a preferred rate, said rate being pre-determined in order to achieve any one or more of: avoidance of damage to the fruit; orientation of the fruit to enable the clustered fruit to be presented to the said cutting means.

According to another aspect of the present invention, said apparatus also comprising a tank for retaining a fluid, said fluid providing the motive force to carry the clustered fruit along the length of the channel.

It should be appreciated that in relation to the present invention, the tank may be either an off-the-shelf option adapted to be used with the invention, or it may be specifically designed to work in conjunction with the invention.

The tank would typically additionally include or be connected to associated electronics, power sources, pipes, pumps, and so forth as required and designed to facilitate the circulation and recirculation of the fluid throughout the declustering process/singularising operation.

The fluid is preferably and typically water. The tank is preferably designed to be capable of holding/retaining at least 300 litres of the water. However, the tank may hold more or less water, depending on the size of the singularising/declustering operation which in turn may dictate the size/dimensions of the singularising/declustering apparatus and the quantity of fruit required to be processed over time.

The water is preferably recycled to the tank to be recycled/reused throughout the length of time the singularising/declustering process is operating.

In some embodiments, the water may be filtered before being recycled/re-used.

The tank preferably includes at least one outlet and one inlet. Said outlet is configured and suitably located to carry/transport the fluid to the specific location where the singularising of the clustered fruit is to be undertaken. The outlet is preferably designed and positioned to deliver and/or direct the fluid adjacent to, or in-line with, the introduction of the fruit in to the singularising/declustering process.

The fluid preferably provides the motive force to carry the fruit along and through the singularising/declustering process. The inlet is preferably configured and suitably located to enable/effect the return of said fluid to the tank after it has been used and passed through the singularising/declustering process.

The fluid is preferably introduced in to the channel at low pressure. Gravity and the configuration of the apparatus can contribute to the motive force along and through the singularising/declustering process.

Said inlet may preferably include filtration means. In one embodiment, the fluid is preferably directed to be passed through a filter conveyor in which a moving conveyor belt includes a sweeping means (such as a brush or other means) for removing debris from the fluid. In various embodiments, said filter conveyor could potentially operate as a stand-alone machine; or, alternatively, it could optionally be built into the tank. Said fluid may also be filtered at the outlet, as well as, or instead of, at the inlet.

The said filtration means may also optionally or preferably include any one or more of an activated carbon filter, a coarse material screen filter or any other filtering means capable of filtering the circulating fluid. While in some embodiments a filtration means may not be present, inclusion of a filtration means is ideally recommended, where possible, to maintain the quality of the circulating and re-circulated fluid throughout/during the declustering process.

The tank also preferably includes a pump to pump the fluid. The pump may be any suitable existing pump system, or may be any pump designed for or adapted for use with the present invention.

Preferably, a flow rate within a range of 2 litres to 10 litres per second per metre of machine width may be accommodated. However, while this is the ideal flow, a flow rate of up to 15-20 litres per second extends the possible ways the machine can be run. Nevertheless, this flow rate is not to be seen as limiting the invention. Rather, the flow rate will be optimised according to the actual physical configuration and/or dimensions of the apparatus, including the channel dimensions and shape. Such information would be important to achieving outcomes, such as determining the capacity of the apparatus to accommodate and/or process ‘x’ fruit per hour, and/or as may be required to configure the apparatus to match further in-line processes upstream and/or downstream, by which the dimensions of the apparatus might be determined.

Accordingly, a range of lower and/or higher flow rates may be required to provide the motive force to carry the fruit along and through the singularising/declustering process.

In addition, however, the fluid/water being pumped throughout the singularising/declustering process preferably flows at a rate and pressure that optimally orientates and/or propels the fruit through the singularising/declustering process at a rate that optimises the singularising process, yet preferably avoids damaging the fruit. The flow rate will typically depend on and/or be dictated by the overall dimensions of the apparatus, the internal configuration of the apparatus and additional features configured within the channel of the singularising/declustering apparatus.

For example, the flow rate may be determined in metres per second (where relevant to the average flow rate) and/or as litres per second, measured at varying locations within and along the channel of the apparatus during the processing operation.

Accordingly, the present invention requires a determination of an optimum flow rate, where the flow rate is not too slow to prevent preferred directional movement and/or orientation of the fruit in order to facilitate successful singularising of the clusters and processing of the fruit; and yet, is also neither too fast to interfere with the ability of the fruit to be engaged by declustering means and/or to cause damage to the fruit.

The fluid/water being used to transport the fruit through the de-clustering process may be maintained at a preferred temperature. For example, cooled water is ideal for fruit preservation, but not essential to the functioning of the singularising/declustering apparatus.

Accordingly, the fluid/water may be cooled to as low as 1 degree Celsius, or be maintained at room temperature (or anywhere in between). The temperature of the water may simply be adjusted depending on the temperature within the processing building. If it is preferable to keep the fruit cool where the air temperature is high, then the water used to transport the fruit throughout the singularising/declustering process, may be accordingly cooled. As previously stated, the water is preferably pumped to the entry point of the singularising/declustering apparatus.

In addition, the fluid/water may be treated with chemicals to maintain a sanitary condition, or, to prevent decay on the fruit. Ozone, Chlorine, Bromine, Periacetic acid and/or other chemicals might therefore be added and the condition of the water automatically and/or manually monitored to maintain it within a desired range.

The singularising/declustering apparatus is preferably configured to include a channel. The term ‘channel’ shall mean, include and describe a component of the structural configuration of the present invention in broad terms. Accordingly, the term ‘channel’ shall broadly mean and refer to a passage capable of conveying/directing/guiding a fluid (and objects carried within or by said fluid) along or through a specified route towards a particular object and/or endpoint.

As such the shape of the ‘channel’ of the singularising/declustering apparatus is defined by its width-depth ratio (w/d) which, along with its length defines a passageway. The passageway dictates the linear direction of the clustered fruit from the point of entry into the channel, to the point of exit from the channel. The fluid/water introduced into the channel at the point of entry carries/funnels the clustered fruit along the length of the channel. As such, the channel can be characterised by measurements of width (w), depth (d), and velocity (v) which make up discharge (Q), along with components of flow resistance (n) and slope (s) all of which impact on the transportation of the clustered fruit along the length of the channel of the singularising/declustering apparatus, where singularisation is effected.

In a preferred embodiment, the channel of the present invention is reasonably U-shaped/U-shaped (in accordance with a standard configuration of a channel). The channel has a first (entry) end and a second (exit) end. It is, however, to be appreciated that a U-shaped/U-shaped configuration and/or the use of the term ‘channel’ is not to be seen as limiting the scope of the present invention.

Having regard to the above, therefore, the channel of the present invention typically includes a base portion and two side portions. The side portions and/or the base portion may each be separately manufactured from separate lengths of material having the required length/width/thickness dimensions and then joined to create the final channel; or, multiple side portions and base lengths resulting in multiple individual panels/sections may be used which are then joined together to create the channel; or, the channel may be moulded as a whole to create the full channel of base and side portions without joints.

The channel base may be between 3 metres and 7 metres in length. Preferably, the base has an optimal length of around 5 metres. However, the channel length in some embodiments may be shorter or longer and may be dictated by the scale of the singularising/declustering process and the quantity of fruit needing to be declustered. Therefore, the lengths as disclosed above should be seen as examples only and should not be seen as limiting the present invention.

In terms of the width of the base of the channel, the width may be between 0.2 metres and 3 metres wide. Alternately, in different embodiments the width of the channel may be between 0.5 m and 2 metres wide: or, a functioning declustering apparatus may have a channel of around 1.5 m wide (or wider). It is to be appreciated, however, that the channel may be of any width required to facilitate the declustering process where the dimensions may be dictated by at least either or both the quantity of fruit required to be passed through the declustering process and/or by the downstream quality control systems that would be typically in-line with the declustering apparatus. Accordingly, the width of the base of the declustering channel may depend on the need for the singularising/declustering apparatus to complement, or correspond with, the width of the downstream production machines.

For example, the declustering apparatus may be simply inserted as part of a processing line. As such, following declustering, the fruit would pass along the downstream processing line via various conveying systems and be scanned by either or both manual and electronic means in order to check and classify the fruit in terms of size, weight, shape, condition, colour, ripeness, and so forth; and then direct the fruit on to the subsequent stages of packing, labelling and processing.

Accordingly, there is no defined functional limit to the width of the channel. Therefore, the widths as disclosed above should be seen as examples only and should not be seen as limiting the present invention.

The channel of the present invention preferably includes side portions that substantially extend vertically from and/or are substantially perpendicular to the base. In various embodiments of the present invention, the height of the side portions may be uniform along the length of the channel of the declustering apparatus; or, may decrease in height (or slope downwards) along the length of the channel of the declustering apparatus; or, may vary in height along the length of the channel of the declustering apparatus.

In some embodiments of the present invention, the side portions may extend to a height of between 0.1 metres to 0.5 metres. However, in other embodiments, the height of the side panels may be dictated by the configuration of the base of the channel. Accordingly, the side portions may extend to a height of less than 0.1 metres or more than 0.5 metres. Therefore, the heights as disclosed above should be seen as examples only and should not be seen as limiting the present invention.

For the purpose of the present invention, it is to be further appreciated that in terms of a manufactured channel, such as described above, the base of the channel defines one of the outer physical structural features of the channel that enables it to contain a fluid and to enable that fluid to be confined as it passes through/along the channel. The fluid flow rate is largely/primarily dictated by a pump (the mechanical device used to raise and/or move the fluid into and along the channel). The pump may be commonly used between other features of the apparatus. In such situations, the flow of fluid over any separator used to enable the fluid to be directed elsewhere may therefore, be determined by one or more valves on the inlet to the channel that may be adjusted to set the flow. Other systems may use a header tank to enable a certain height of water to set the flow rate.

The base width will also impact on the characteristics of that fluid/water flow, and the shape of the channel will dictate the direction of the flow. In a situation where the pump is set to a preferred litres per second rate, then in embodiments where the base of the channel might be substantially flat (horizontal), the flat ‘base’ may typically enable a steady fluid/water flow through the channel. Where the base slopes downwards and/or is uneven or non-uniform along the length of the channel the flow of the fluid along and through the channel may be either accelerated or slowed, accordingly.

Having regard to the above, therefore, in one embodiment of the present invention the base of the channel may operate as both an important structural feature of the channel and the shape/configuration and dimensions of the base further define the ‘channel bed’. Accordingly, the channel will include the feature as a single ‘base-bed’ configuration. However, in another embodiment of the present invention, the base may operate solely as part of the outer structural feature of the channel, and there is included a separately configured ‘channel bed’ located above and/or separated from the base. Accordingly, the channel will include two features—in a ‘base+bed’ (base plus bed) configuration.

For the purpose of the present description, when referring to a configuration where either of the above options may be relevant to any embodiment (as either or, or both configurations), this will be indicated by the terminology ‘base/bed’.

For the purpose of the present invention, the term ‘channel bed’ is defined by physical features that influence the characteristics of the water flow and/or impact on the flow dynamics of the fluid passing through the channel. However, this term and definition should not be seen as limiting the present invention or embodiments thereof.

In accordance with one embodiment of the present invention, the base of the channel/channel bed is substantially flat. In another embodiment of the present invention, the base of the channel/channel bed is substantially sloping. In yet a further embodiment of the present invention, the base of the channel/channel bed is substantially stepped. In another embodiment of the present invention, the base of the channel/channel bed is substantially undulating. In other variations to the invention, the base of the channel/channel bed may include any one or more of the above options.

In one embodiment, where the base of the channel/channel bed is substantially undulating, the configuration includes a series of undulations.

For the purpose of the present invention, the term ‘undulations’ shall mean and describe a rising and falling of the base/bed or a portion of the base/bed in a wave-like configuration, or, as may be seen in a slow sine wave form or configuration. Each undulation will reasonably have both a peak and a trough associated with the peak of interest.

Depending on the context of the description, the trough discussed per peak may be deemed to be the forward trough—before the peak—or the trailing trough—after the peak. However, it should be appreciated that this terminology should not be seen as limiting the present invention.

Accordingly, in some embodiments of the present invention, each undulation may be deemed as being centred on the wave peak (upstream rising, downstream falling); or, alternately, in other embodiments, each wave may be centred on the wave trough. It should be therefore appreciated that in various embodiments of the present invention, any one, or more (in combination) of the following arrangements may be employed.

For example, the undulations may vary in height and width along the length of the base/bed: or, may be uniformly configured/dimensioned along the length of the base/bed, or may successively increase or decrease in height and/or width along the length of the base/bed; or, may have alternating configurations of width/height along the length of the base/bed; or, may be differently configured at the beginning/end/middle of the base/bed length; or, may be uniformly/evenly spaced along the base/bed: or, may be spaced apart along the length of the base/bed with varying differences between each ‘wave-like’ undulation: or, said undulations may be spaced closer together at the entry end of the base/bed and separated wider apart towards the exit end of the base/bed.

Given the optional configurations of the base/bed as described herein, it should be appreciated that these are provided to exemplify a range of embodiments, which may be appropriate to declustering different fruits. Accordingly, they are not intended to limit the scope of the present invention to only these options.

According to one aspect of the present invention, said undulations are preferably spaced along the length of the base at uniform intervals of 0.4 metre. However, alternately, said undulations are able to spaced between 0.2 metre (minimum) to around 0.6 metre (maximum) apart. Any suitable spacing may be employed within various embodiments of the present invention. However, for example, in one embodiment, the spacing of the undulations may be within a range of 0.33 metre to around 0.45 metre.

It should be appreciated that the spacing of the undulations may be dictated by and be dependent on the length of the channel and/or the force of the water and/or the concurrent requirement to minimise damage to the fruit and/or the characteristics and type of fruit that is required to be singularised from a cluster; an/or the stem length of the fruit (which might vary between different varieties of the same fruit).

Therefore, there is no defined upper and lower functional limit to the spacings between the undulations as these may vary depending on such factors, or on factors in addition to those referenced above.

Accordingly, the spacings as disclosed above should be seen as examples only and should not be seen as limiting the present invention. However, the spacing between the undulations may be further dictated by and be dependent on the height of waves.

In terms of the potential/possible height(s) of the undulations (rising from the base of the wave to the top of the wave), a height range may be between 30 mm (minimum) and 120 mm (maximum) at the top of the wave. For example, in one embodiment, the undulations may be configured to a height within a range of 80 mm-100 mm. In yet another embodiment of the invention, the undulations may have a preferred optimum height of 90 mm. It should, however, be appreciated that these values are provided as examples of potential embodiments and therefore variations below and above these values may be possible and be influenced by whether the measurement is taken as being perpendicular to the base versus vertical.

However, it should be appreciated that the heights of the undulations may be dictated by and/or be dependent on the height of the sides of the channel and/or the force of the water and/or the concurrent requirement to minimise damage to the fruit and/or the characteristics and type of fruit that is required to be singularised from a cluster. It should be further appreciated that the heights of the undulations may be very dependent on the embodiment of the cutting means/mechanism. Therefore, again, there is no defined upper and lower functional limit to the height of the undulations as these may vary depending on a series of factors, including and in addition to those referenced above.

Accordingly, the heights as disclosed above should be seen as examples only and should not be seen as limiting the present invention. In accordance with another embodiment of the present invention the arrangement and configuration of the undulations may involve undulations having a reduced height at the entry of the channel when compared with the height at the exit end of the channel (or vice versa). This arrangement may be dictated by the efficiency of the declustering process and if/where the optimum declustering occurs along the length of the channel.

In addition, each subsequent undulation may have both the peak and trough of the channel being configured to be lower than the previous (upstream) wave. For example, the reduction in height per undulation in one embodiment may be between 20 mm to 100 mm. In one preferred embodiment the reduction in height per wave is about 60 mm. In yet another preferred embodiment, the reduction in height per wave is about 45 mm. This successive reduction in the height of subsequent waves has been found to contribute to creating water flow across the base/bed of the declustering apparatus at a preferred rate. However, it should again be appreciated that the heights of the successive undulations may again be dictated by and be dependent upon various factors, such as (but not limited to) the force of the water and/or the fruit that is required to be singularised from a cluster.

In accordance with another aspect of the present invention the base, bed and/or the channel per se may also or be sloped downwards from the entry end of the channel, to the exit end of the channel. This arrangement is able to contribute to the water flowing naturally down the channel, relying as much on the angle of the slope and on gravity as on the fluid/water pumping system employed and used with the invention.

In terms of the above aspect of the present invention, it may be reasonably understood that where the base of the channel is the bed of the channel (‘base-bed’ configuration), or where the channel is configured to have a ‘base+bed’ configuration, each subsequent undulation may have both the peak and trough of the channel configured to be lower than the previous (upstream) wave. However, the actual base-bed configuration and/or the base+bed configuration may nevertheless be either horizontal, or it may be angled/sloped.

Therefore, it will be appreciated that in configurations that employ the ‘base-bed’ configuration, all of the base, the bed n, the channel per se may be sloped downwards. However, in that same configuration, when the base, the bed and the channel per se are horizontally arranged, then no individual part of the base, the bed r the channel may be able to be sloped downwards.

Alternatively, it will be appreciated that in configurations that employ the ‘base+bed’ configuration, any one, or all of, the base, the bed and the channel per se may be sloped downwards as a whole or singularly.

Accordingly, one configuration, may be that the bed is able to slope downwards, while the base and the channel remain horizontal. Alternately, the bed may be horizontally configured, whilst the base may slope downwards as a feature to facilitate drainage of any fluid that may leak from and below the bed and collect on the base. Or, all of the base, the bed and the channel may be sloped downwards—by having a substantially horizontally configured embodiment simply elevated at one end. Accordingly, one structural feature does not limit or prevent any other individual part—whether the bed 2 the base, or the entire channel—from being configured to slope downwards if the base+bed configuration is employed.

It should again be appreciated that the features of the slope of the channel base/bed (such as the angle of slope), may again be dictated by and be dependent upon various factors, such as (but not limited to) the force of the water and/or the fruit that is required to be singularised from a cluster. Accordingly, as with the reduction in the height of successive undulations, any preferred angle of slope of the channel base/bed, as disclosed above, should be seen as an example of one embodiment and should not be seen as limiting the present invention.

Within one embodiment of the present invention, the number of waves situated along the channel is ten. However, in other embodiments the number of waves could be increased or reduced, subject to testing and after consideration of a number of additional factors, such as being dependent on the fruit being declustered and/or the efficiency of the singularising process, and so forth.

It is to be noted that one benefit of the present invention is that the undulations slow down the transport of the fruit along the channel, by effecting a partially deeper area before the forward face of the undulation/wave. As the velocity of the water is reduced/slowed, then there is less likelihood that the fruit (being carried by the water) will be bruised or damaged by the process. However, the force of the water and the buoyancy of the fruit contribute to enabling the fruit to be carried up and over the top of the undulation.

The fruit and water then travel quickly up the forward face of the undulation and across the top of the wave (the crest) and down the trailing face or slope of the undulation (wave), to where the fluid/water and the fruit again slow down through what is the deeper part relevant to the trough before the face of the next wave undulation. The flowing water then propels the fruit up the forward face of that undulation, similarly speeding up as it approaches the crest (the top) of that next wave . . . and so on along the channel.

As the undulations slow down the transport of the fruit along the channel, at the point of each deeper section before the forward face of each undulation and in the trough after the trailing face of each undulation, the potential to further regulate the speed of travel of the fruit through and along the channel is possible and the configuration of the base/bed may, therefore, be tailored for use with specific fruit.

In addition, as the speed of the water is reduced, the potential exists for the natural weight of the fruit to assist with the subsequent positioning of the fruit so that the fruit leads as it is carried across the crest of the undulation and the joining point/knuckle/abscission zone of the clustered fruit then trails.

Alternately, in some instances, as the fruit rolls over the crest of the wave the joining point/knuckle/abscission zone of the clustered fruit may lead and the fruit trail. Alternately, fruit clusters may travel along the channel and as the fruit rolls over the crest of the wave, one fruit (cherry) may be leading and so will be tugging the others that are joined to it within the cluster.

However, in any such instances, what is desirable is that the joining point/knuckle/abscission zone of the clustered fruit is optimally positioned for the process of singularising the clustered fruit. Such singularising is effected by exposing the joining point/knuckle/abscission zone of the cluster to cutting means at the optimal position to ensure preferred slicing through the joining point/knuckle/abscission zone of the clustered fruit and hence separation of the clustered fruit, whereby each separated fruit retains a single, intact stalk, with preferably no damage to the stalk, no portions of other stems of the adjacent fruit of the same particular cluster and no damage to the fruit.

In various other embodiments of the present invention, where the base/bed is differently configured, a benefit of the present invention is to enable the fruit to be carried along and/or down the channel by the fluid/water, either at a reduced speed and/or be slowed down at specific locations along the channel, in order to avoid damage to the fruit, and/or assist with positioning the fruit in a preferred alignment and/or retain the fruit in a position required in order to better present the fruit and/or position the fruit in advance of cutting means used with the invention to singularise/decluster the fruit.

Having regard to the above, the addition of various structures onto or into the wave profile may adjust or influence the flow of water and/or the fruit. These could take the shape of humps, fins, speed bumps, flaps, guides or other shapes that assist in preferentially directing the water and fruit and avoid becoming tangled with fruit. Speed bumps in particular can adjust the depth of the slower water section in the trough of the wave by simulating a higher following crest over a short space.

In relation, to any of the above, the desired outcome is that the fruit advance towards cutting means, used with the invention, to singularise/decluster the fruit.

Therefore, according to a preferred embodiment of the present invention the singularising/declustering apparatus also includes cutting means.

For the purpose of the present invention. ‘cutting means’ shall mean and include any device, apparatus or system, designed specifically for, or adapted for use with, the present invention. The cutting means is required to cleanly slice, shear, cut through the joining point/knuckle/abscission zone of the clustered fruit, such that the fruit is singularised but with the single, individual stem of each fruit (within the cluster) being intact, connected to the fruit and cut cleanly at the joining point/knuckle/abscission zone. Accordingly, it is one object of the present invention to minimise and/or avoid fruits having no stalk retained after the singularising process. It is another object of the present invention to minimise and/or avoid mis-cuts that would result in shortened stalks. It is a further object of the present invention to minimise and/or avoid stalks which include a hook or part of the stalk of a neighbouring fruit within the same cluster. In addition, it is an object of the present invention to avoid damaging the fruit during this process. It is to be noted that cleanly slicing through the joining point/knuckle/abscission zone of the clustered fruit is not necessarily, by extension, always better for ensuring the preservation of the stem. However, it is what the market currently appears to demand.

In various embodiments of the present invention cutting means are preferably individually arranged at a designated location within the channel of the singularising/declustering apparatus. In said embodiments, there are preferably multiple, individually arranged, cutting means. In said embodiments, the cutting means are preferably spaced across the width of the channel and along the length of the channel.

The singularising/declustering apparatus is configured such that the cutting means are adapted to be arranged at preferred locations and in preferred numbers across and along the channel. In various embodiments of the present invention, the number and arrangement of the cutting means may be uniform along the length of the channel and/or across the width of the channel; or, the cutting means may be arranged or configured in groups of set numbers of cutting means where the cutting means are spaced closer together and/or further apart; or, the locations of the cutting means of one group may be in-line with the arrangement of previous or subsequent groups of cutting means; or, the locations of the cutting means of one group may be offset from the locations and arrangement of previous or subsequent groups of cutting means; or, the number and arrangement of the cutting means may vary in number depending on their location within and along the channel—for example, from potentially a few cutting means at the beginning of the channel to an increasingly greater number further along/down the channel or vice versa; and so forth. It should, therefore, be appreciated that any variation to the number and arrangement of the cutting means is possible within the ambit of the present invention.

Each of the cutting means of the present invention is preferably elevated over/above the base and/or bed of the channel. This arrangement is adapted to enable the clustered fruit to be presented to the cutting means in a manner enabling the fruit to hang below the cutting means, with the knuckle or joint of a fruit cluster being presented onto and/or into the cutting means.

This arrangement means that the continuing flow of the fluid/water across and around the fruit creates a drag against the dangling fruit, thereby pulling at and against the fruit. In addition, gravity contributes to the drag on the fruit dangling below the cutting means. Thereby, the drag, created by the water flowing past the dangling fruit and/or by the gravity effect, is able to contribute to the stalks of the clustered fruit being positioned in a preferred location and at a preferred orientation for the cutting means to cut through the knuckle/joint/abscission zone of the cluster. Additional ways to suitably position/orient the fruit are discussed later, such as locator means/walking effects, and so forth.

This pull, in conjunction with the knuckle/joint being caught by the cutting means, also provides resistance that may assist in forcing the knuckle against the cutting means which may assist in the cutting stage.

In one preferred embodiment of the present invention, where the base/bed is configured to include undulations, each cutting means is located on, or within, the crest of the undulation and preferably on the downstream side (trailing face) of an undulation. This positioning is designed to catch the clustered fruit as the water/fluid flow causes the clustered fruit to speed up as it passes over the crest of the undulation and while it descends downward towards the next trough. In this situation, the clustered fruit travels down but, the stem is retained at the level of the cutting means, causing the fruit to be suspended.

In preferred embodiments, the cutting means includes a body and at least one blade portion. The blade portion may be fixed (unmoveable), or moveable.

In preferred embodiments of the present invention, the body of the cutting means includes and/or operates as housing for the blade portion. The housing may take any appropriate configuration and, in addition, the housing may operate as a sheath that substantially encloses the blade portion when the blade portion is not in an operational cutting configuration, but the housing may also be configured to enable the blade portion to move within the housing such that the blade portion may be presented from a covered (sheathed) position to an uncovered, cutting (unsheathed) position.

In such embodiments where the blade portion operates between sheathed and unsheathed positions, the body may also be configured and adapted to accommodate a driving mechanism.

For the purpose of the present invention, the term ‘driving mechanism’ may be understood to refer to any system, device and arrangement that may use and include any combination of power sources, motors, cam shafts, drive shafts, pulleys, belts, gears, pneumatic cylinders and/or hydraulic systems and so forth. The driving mechanism may be an off-the shelf item or, may be specifically designed and purpose built for use with the present invention. In addition, the driving mechanism may be adapted for use with other configurations of the cutting means, wherein either or both the housing and the cutting means is adapted to and/or required to move relative to each other in a configuration that facilitates the cutting action required to separate the clustered fruit at the joining point/knuckle/abscission zone of the cluster. Accordingly, it should be appreciated that the use of this term should not be seen as limiting the scope of the present invention.

In addition, the driving mechanism may be used in conjunction with sensors, said sensors triggering the operation of the driving mechanism. Such sensors may be motion or weight detecting sensors—detecting and being triggered by a fruit cluster contacting a relevant portion of the cutting means, and/or may be photosensors detecting levels of, or the colour of, light—activating when the light level changes (such as when a knuckle of a fruit cluster blocks the light) or being triggered by the colour (such as being programmed to detect the colour of fruit stalks/cluster knuckles). Other sensors relevant to the operation of the invention may also be employed.

Accordingly, in at least one preferred embodiment of the present invention, the driving mechanism is configured to facilitate directional movement of the housing and/or of the blade portion.

As such, the housing of the body of the cutting means may be configured to enable the blade portion of the cutting means to move through a horizontal plane, or a vertical plane and the movement may be linear, circular, oscillating/pivoting, reciprocating, and so forth. In addition, the movement may be uniform (constant) or non-uniform (with the speed of said movement varying).

Further, in embodiments where the housing of the cutting means operates as a sheath for the cutting means, the driving mechanism (in conjunction with any relevant sensors) may trigger/direct movement of the blade portion from a recessed or unexposed (sheathed) position to an exposed (unsheathed) position to enable the blade portion to be available to cut through the knuckle/joining point/abscission zone of a cluster of fruit.

Accordingly, when the blade is sheathed, the knuckle/joining point of a cluster of fruit is able to be located into or onto the cutting means. Then, when the blade is exposed/unsheathed, the cluster of fruit is able to be cut at the knuckle/joining point/abscission zone and the stems of the clustered fruit are thereby separated and individualised and the fruit (with its individual intact stalk) is able drop free of the cutting means.

For example, in one embodiment of the present invention, the cutting means operates through a reciprocation cycle such that it enables the blade portion to move through repetitive up-and-down or back-and-forth strokes, in a linear motion. The driving mechanism of the present invention however, preferably enables the blade portion of the cutting means to operate between a position where the blade is hidden (sheathed by the housing) and a position where the blade is exposed (unsheathed) only when the knuckle/abscission zone of a cluster of fruit is presented for cutting. This is beneficial as the sheathing of the blade prevents the body of the fruit from accidentally coming into contact with the reciprocating blade. Additional ways to suitably position/orient the fruit to avoid/minimise fruit damage, are discussed later, such as locator means/walking effects, and so forth.

In alternative embodiments, the blade portion of the cutting means may be configured to oscillate, move through/pivot through a vertical plane, rotate, and so forth. In addition, in accordance with various embodiments of the present invention, the housing itself may be substantially horizontally or vertically aligned, or it may be angled (such as positioning it to be aligned to the downward angle of the downstream face of an undulation, for example).

Accordingly, the various embodiments of the present invention, enable the housing and the cutting means to be specifically configured, arranged, adapted and operated as may be required to effect declustering of a range of various clustered fruits, having regard to the type of clustered fruit and the need to accommodate any requirements inherent in declustering said different fruits without damaging the body of the said fruit.

Therefore, in accordance with yet another aspect of the present invention, as the clustered fruit is being transported by the water flow and carried over the crest of an undulation of the base/bed of the channel, the housing may be configured (in various embodiments) to include features designed to specifically capture and temporarily retain the clustered fruit. Preferably, the clustered fruit will be captured and retained in an orientation best suited to position the junction point/knuckle/abscission zone such that the blade of the cutting means is able to cleanly cut into the knuckle, enabling the clustered fruit to be separated and, as such, then released into the fluid/water stream to be carried downstream towards the end of the channel.

For the purpose of the present invention, any feature(s) designed to temporarily stop, capture, hold and/or retain the clustered fruit (as discussed above) shall be referred to as an ‘arrestor means’, although, it should be appreciated that this term is not to be seen as limiting the present invention. Accordingly, the arrestor means is employed to temporarily stop or prevent the clustered fruit from simply being carried over the cutting means and taken further down the channel by the flow of water. The arrestor means may be an indentation or incision on the edge or surface of the housing (such as a notch, groove, slot, slit), or its configuration may be a small protrusion extending from the housing (such as a knob, lip, slope, and so forth). The configuration of the arrestor means may be simple, or it may be more complex, depending on the clustered fruit required to be singularised.

In accordance with another aspect of the present invention, there may be single or multiple (double, triple, and so forth) arrestor means spaced out along the length of the horizontal housing.

The housing of the cutting means may therefore include any number of appropriately configured (vertical, horizontal, angular, indented, nodular) recesses or cut out sections or extensions or protrusions. Accordingly, they may be substantially U-shaped (notched), V-shaped (triangular notch), castellated, angled (lead-in) or reversed in orientation; and/or, otherwise similarly or alternatively configured protrusions into which or against which the knuckle/joining point/abscission zone of the clustered fruit may be caught and temporarily retained, such that that the path of downstream movement of the clustered fruit is temporarily prevented in order to enable and facilitate stem separation.

Further, in the various embodiments of the present invention, it is preferable that the dimensions of any arrestor means feature be limited such that only the knuckle/joining point/abscission zone and/or a portion of the of the fruit cluster is able to fit inside or be held against said arrestor means and thereby ensure that only the knuckle/joining point/abscission zone of the fruit cluster is able to come into contact with the blade of the cutting means. However, the body of the fruit is not able to, and preferably does not, come into contact with the blade of the cutting means.

The dimensions of the various forms of arrestor means are, therefore, relevant to and important to the operation of the invention. Where the arrestor means is a recess, the width of the recess may be anywhere between 5 mm-15 mm wide, although in such embodiments the width may optimally be in the vicinity of 8 mm-12 mm wide. In addition, the depth of the recess may be anywhere between 1 mm-15 mm deep, although, in such embodiments the depth may optimally be in the vicinity of 10 mm-11 mm deep.

According to a further aspect of the present invention, the cutting means may also include locator means. For the purpose of the present invention the term ‘locator means’ shall mean and refer to any system, device or structure associated with the arrestor means and/or the cutting means that provides directional assistance to enable the clustered fruit to be progressed towards and/or within the arrestor means and towards the blade of the cutting means. However, use of the term ‘locator means’ should not be seen as limiting this invention and therefore any alternatively named device, system or structure, that operates to achieve the same or similar outcome, shall be broadly included within the ambit of this invention.

As such, the locator means is a mechanical device that is used to facilitate and encourage the clustered fruit to move and/or progress towards the blade portion in order that the cluster is able to be appropriately positioned for singularising the cluster by the blade portion. The locator means, by operating as a directional aid, substantially offers and provides an improvement to the singularising of clustered fruit, particularly where the fruit and/or the cluster may be large, heavy or not easily or reliably presented in the appropriate position to enable the fruit to be singularised in the manner required to meet the preferred/desired standards dictated by either or both the process and the market. For example, it should be appreciated that in situations where the fruit stem is short, the fruit may not be or is not reliably pushed by the water stream. Accordingly, the locator means to facilitate and encourage the clustered fruit to move and/or progress towards the blade portion is particularly beneficial.

In one embodiment of the present invention, the locator means is configured to operate, in part, as an arrestor means but, apart from contributing to the capture of the fruit cluster, the locator means portion is more relevantly adapted to directionally move the fruit cluster towards the location of the blade of the cutting means, in order to position the joining point/knuckle/abscission zone of the clustered stems on or adjacent the blade so that the knuckle/joining point/abscission zone is able to be severed by the blade.

The locator means (whether within a recess or not) preferably not only facilitates and encourages the clustered fruit to move positively towards the blade but also helps to prevent fruit clusters from becoming trapped, reduces the potential for blockages to occur and thereby beneficially improves throughput.

Therefore, in accordance with the various embodiments of the present invention, the locator means may be, include and/or operate as, an adapted conveyor system.

It will be appreciated that there is and may be a range of possible alternatives that may be designed, used with or adapted for use with the present invention in order to achieve the desired outcome of progressing the clustered fruit directionally towards the blade portion. For example, the locator means may be and/or include a screw based system; or, may require a modified cutting means housing and/or blade portion that may be adapted to essentially include configured sections that are adapted to be successively presented/elevated/raised up and lowered to ‘walk’ the fruit forward; and/or may be an adapted conveyor system.

For example, in embodiments of the present invention, a screw based system may include an auger. Further, any other system that essentially ‘walks’ the fruit forward may be used. Such systems may include vibratory, shaking, oscillating or reciprocating motions; and/or conveyor systems may include embodiments incorporating rollers, belts or bands. Accordingly, any one or more options could be used to convey the clusters towards the blade portion.

Depending on the systems designed for and/or employed with the invention, the locator means may be operated by or powered by the same mechanism as that used to power the reciprocating blade functionality; and/or, the systems could operate simply based on the pressure of the flowing water, and/or via the inclusion of additional mechanical, pneumatic and/or hydraulic systems. In relation to any locator means system employed with the present invention, said system will be a directional system having a particular direction of motion, progression, or orientation in order to direct the clustered fruit along a preferred pathway.

It may be appreciated that the current invention lends itself to various embodiments and alternatives, in a range of tangible, visual and operational forms. Accordingly, it will be appreciated that the various possible embodiments, while being comprised of unifying features and being directed to effect the same desired result, may nevertheless look and operate differently. However, while some of the alternatives and variations have been exampled and described herein, it should be appreciated that these alone should not limit the present invention.

Accordingly, in yet another variation of the present invention, the cutting means of the present invention may be included on, or in relation to, a vertically aligned and rotating wheel—designed substantially like a ‘water wheel’. Said wheel including projections spaced around the outer circumferential edge of the wheel. Said projections designed to be exposed to the directional pressure of the flowing water, forcing said wheel to revolve. Said projections also being configured to capture the clustered fruit, and potentially operate as locator means to position the clustered fruit relative to the cutting means.

In addition, the wheel may also serve as, or include, the cutting means, where the circumference of the wheel is adapted to provide a cutting edge, or where the circumference of the wheel includes blade portions, either of which being adapted to cut through the joining point/knuckle of the clustered fruit as the clustered fruit is carried on and along the edge of the wheel by the force of the water and/or by the weight of the fruit cluster and/or by mechanical means.

In preferred embodiments, the blade portion may include at least one upturned cutting edge capable of contacting the knuckle/joint of the clustered fruit. It should, however, be appreciated that the blade may be profiled in various ways. For example, the blade may include a substantially horizontal, vertical, angled or curved cutting edge; and/or, the blade may include multiple cutting faces/edges. In addition, the cutting edge may be smooth, serrated, or otherwise configured and it may or may not be sharpened, depending on the fruit clusters being singularised and/or the thickness of the knuckle/joint of the cluster required to be cut through.

In one embodiment, the cutting edge may be of a sharpness and configuration adapted to cut through the knuckle/joint/abscission zone of the clustered fruit.

Alternately, the cutting edge may be substantially blunt and the pressure of the knuckle/joint against the edge, (potentially contributed to by the pressure of the water pulling down on the suspended fruit), may be sufficient to enable the upturned cutting edge of the blade portion to operate like a guillotine sufficient to cut through the joining point/knuckle/abscission zone of the clustered fruit.

In some embodiments of the present invention, the blade may be fixed (whether the blade is horizontally arranged, vertically arranged, sloping or circular). Accordingly, where the pressure of the water causes the fruit to be transported forward along the blade then that directional movement of the fruit cluster may be sufficient to enable the edge of the blade to shear through the joining point of the clustered stems.

In other embodiments, where the blade portion of the cutting means may be stationary (fixed), the cutting means may simply pivot substantially downwards from a substantially horizontal plane when the cutting means receives a cluster of fruit and then return (spring back) from a downwards angled position to a subsequently horizontal arrangement when the weight of the fruit is no longer present.

Again, the directional movement of the fruit cluster may be sufficient to enable the edge of the blade to shear through the joining point of the clustered stems. In the case of these latter options, there may be cost benefits to not having to replace or re-sharpen the blade perhaps as frequently as might be the case if the operation of the cutting means was dependent upon maintaining the edge of the blade sharp.

However, where the cutting of the fruit cluster is typically effected via a reciprocating shearing action, then in such embodiments, the water force may not play a significant part in the cutting action, said water force instead contributing primarily to the transportation of the clusters onto the cutting means.

Therefore, in various embodiments of the present invention, the blade portion may be mechanised. For example, the blade portion may be mechanised to enable it to reciprocate (vertically or horizontally), to rotate, or to oscillate. Where the blade is configured to be reciprocating, rotating, or oscillating, the blade may be operated by any one or more of hydraulic, pneumatic, or mechanical means designed for, or adapted for use with, the invention.

Preferably, the cutting means cuts into the knuckle/joining point/abscission zone in a single stroke, rather than employing a ‘sawing’ action. However, given that some knuckles/abscission zones of some clusters may be large and thick, it should be appreciated that it could take multiple cuts to complete the singularising of a cluster of fruit.

In accordance with various embodiments of the present invention, it should be appreciated that the apparatus for singularising clustered fruit may operate as a stand-alone invention; or, it may form part of a fuller processing chain, in which the apparatus is inserted in-line at the relevant stage where the clustered fruit is required to be prior singularised before other quality control and packaging stages can be undertaken.

Accordingly, it will be appreciated that in various embodiments of the present invention, the apparatus will typically include a frame. Said frame being adapted to secure and stabilise the channel and its components, along with providing an option for securing the fluid tank, if desired/required. In addition, the frame may be adjustable to enable the channel to be positioned at a height where the entry to the channel is accessible for the introduction of the clustered fruit and/or at a height where the exit point of the channel is able to complement the height of any subsequent machinery, conveyor belts and so forth.

In addition, it will also be appreciated that the present invention may also be adapted to connect to such other components of any system/device required to feed the clustered fruit in to the entry of the channel, or direct the singularised fruit from the end of the channel towards downstream processing systems.

Further, it should be appreciated that given the fluid/water provides the primary motive force for carrying the clustered fruit through and along the channel of the present invention, it is relevant that additional features may be included, such as drip trays and so forth, to prevent/minimise the likelihood of the fluid overflowing and/or spilling on to the surface on which the declustering apparatus is standing, and/or on to a platform that an operator may be standing on, and also enabling that fluid to be recycled back to the tank system of the invention.

Accordingly, the flow of the water will subsequently carry the abscised fruit (preferably and ideally bearing a single, intact, stalk) further along the channel and direct it towards the exit point of the channel where the singularised fruit is separated from the liquid/fluid/water of the channel and the water/fluid is then filtered and returned to the tank to be recycled back to the inlet of the channel. At that point, the declustered fruit exits the end of the channel and is made available to be subsequently carried via conveyor or other systems to downstream in-line systems designed to enable the fruit to undergo quality control, grading, sorting and packaging. Alternatively, rather than the water being separated out and then the fruit proceeding along the line (as indicated above), both the water and the declustered fruit may be carried towards the next (in line) machine, which then may typically drain the water and return the water to the tank.

It will be appreciated that there are a number of components relevant to the present invention. Accordingly, those various components of the declustering apparatus may be manufactured from any suitable materials that are strong enough and durable enough, relevant to the requirements of each of the said components/features.

As such, the various components may be made from metal, such as steel (preferably stainless steel) and/or aluminium, where this is required to provide the optimum strength to accommodate various forces and minimise wear and tear. Other components of the apparatus could be made from other materials, such as thermoplastic materials (including reinforced thermoplastic materials) and or any combination of various materials, as required to provide strength, stability and durability to the components.

In using the singularising apparatus, the following steps are followed:
a) Stabilise the apparatus on/against a surface on which it is to be used; and
b) Initiate the circulation and re-circulation of the fluid through and along the channel at a preferred flow rate; and
c) Introduce the clustered fruit (required to be singularised) into the channel at the entry of the channel; and
d) allow the clustered fruit to be carried along and down the channel and be directed towards and be engaged with the cutting means; and, in embodiments where the cutting means are mechanised and/or rely on hydraulic/pneumatic systems, engage said systems; and
e) Monitor the progress of the clustered fruit along the channel to ensure the fruit is appropriately singularised in accordance with the standards of quality desired; and
f) Allow the singularised fruit to exit the channel and progress towards any further stages (downstream/in-line); and
g) Separate clusters of fruit that have not been singularised and re-introduce the said fruit clusters into the channel at the entry of the channel. It should, however, be appreciated that where the fruit clusters are not singularised, they may (more commonly) continue on with the singularised fruit, pass through the grading systems, and then be reintroduced automatically back to the start of the invention by a recirculation system. Intervention would only be required for any clusters that become stuck in the invention, which should be relatively uncommon in a good implementation of the design.

Having regard to the above description, it should be appreciated that the apparatus and the method for singularising clustered fruit provide a means for separating clustered fruit in a way that can provide potentially realisable advantages, in so far as any one, or more, of the following are possible. For example:
1. There is a greater likelihood of ensuring correct slicing through the joining point/knuckle/abscission zone of the clustered fruit; and/or
2. There is a greater likelihood that the invention assists in avoiding or reducing singularised fruit with loss of stalks, broken stalks and/or hooked stalks; and/or
3. The undulations of the base/bed contribute to slowing down the transport of the fruit along the channel, by effecting a partially deeper point before the face of the undulation. As the speed of the water is reduced, so is the likelihood that the fruit will be bruised or damaged by the process: and/or
4. As the bed/base of the channel may be sloping, the speed of the water pumped in to the channel is able to be reduced, and therefore this may translated to yet a further reduction in the likelihood that the fruit is bruised or damaged by the process; and/or
5. As the invention enables the natural weight of the fruit to assist in positioning the fruit so that the fruit leads as it is carried across the crest of the undulation, then the joining point of the clustered fruit trails and so it is more likely that the knuckle/joining point/abscission zone of the fruit cluster is able to be correctly positioned on the cutting edge of the blade of the cutting means to ensure preferred slicing through the joining point of the clustered fruit and separation of the clustered fruit; and/or
6. As the clustered fruit is supported within water, the individual fruits are easily diverted along each side of the cutting means without any, or minimal, impact force that could bruise the fruit; and/or
7. As the water naturally travels around the cutters and the clustered fruit merely is carried along by the flow, only the stems are carried onto the cutting means—such as when each fruit in a pair goes either side of the same cutting means; and/or
8. The design has contributed to improving the safety of the current invention over conventional fruit cluster cutting means, as the blades are mostly contained within blade sheaths, and are not fast spinning; and/or
9. The design offers greater ease of cleaning over conventional cluster cutters as the blade drive mechanism is able to be located under the channel base/bed, rather than above it; and/or
10. As there are less projections for the fruit clusters to get stuck on compared to the blade guards on a conventional cluster cutters, this can lead to improved reliability and less blockages; and/or
11. As there are less projections for the fruit clusters to get stuck on compared to the blade guards on a conventional cluster cutters, then any blockages that do occur are more likely to be easier to clear as the apparatus is both open on top and relatively safe to access; and/or
12. As the clusters settle on the cutting means with the assistance of gravity, and as the clusters are partially suspended in the fluid/water, there is no adjustment required for accommodating different lengths of stem, so it predisposes the cluster to being cut at the stem knuckle/joining point/abscission zone.

It should be appreciated that the above listed advantages (and the potential these advantages offer) are provided as examples only, and they are not intended to be limiting, having regard to the scope and adaptability of the present invention as well as to the range of possible variations covered by the described invention.

It should, therefore, be noted that clustered fruit in the context of the present invention includes cherries. However, the invention also has application for other fruits that similarly result in clusters of the fruit that require separating or where separation is desirable to meet market demand or quality standards.

In the context of the present invention, separation is preferred:
To meet market demands for declustered fruit; and/or because
It enables fruit that is within a cluster, but damaged, to be effectively and easily separated from the good fruit; and/or
It enables various grades of good fruit in a cluster to be separately graded for maximum profit: and/or
Clusters may and do get stuck in most of the downstream sorting, quality control and packaging equipment leading to blockages.

Further, the apparatus is adapted to be:
1. Cost effective; and
2. Designed for use with a wide range of commercial fruit crops where the fruit grows in clusters that are required to be separated for various reasons; and
3. Compact and able to be used as a stand-alone apparatus, or for use in-line with processes for sorting, grading and packaging such fruits; and
4. As large as may be required for other uses; and
5. Easily moved from one location to another; and/or
6. Easily assembled; and/or
7. Require minimal maintenance; and
8. Easier to clean; and
9. An improvement on and/or more accurate in singularising clustered fruit than any other existing system; and
10. Safer to use than any other existing system available; and
11. Potentially faster than other conventional cluster cutters (in so far as the potential exists for the apparatus to improve the processing of clustered fruit and in so doing reduce the re-handling time required to reprocess fruit that remain in clusters after passing through the apparatus).

It will therefore be appreciated that the invention broadly consists in the parts, elements and features described in this specification, and is deemed to include any equivalents known in the art which, if substituted for the prescribed integers, would not materially alter the substance of the invention.

Variations to the invention may be desirable depending on the applications with which it is to be used. Regard would of course be had to effecting the desired size, useability, cost of the cutting apparatus and so forth, dependent on the requirements of the user—such as how much material is to be cut, frequency of use, type of material to be cut (hard/soft), cost requirements, and so forth.

Whilst some varying embodiments of the present invention have been described above and are to be yet exampled, it should further be appreciated different embodiments, uses, and applications of the present invention also exist. Further embodiments of the present invention will now be given by way of example only, to help better describe and define the present invention. However, describing the specified embodiments should not be seen as limiting the scope of this invention.

### BRIEF DESCRIPTION OF DRAWINGS

Further aspects of the present invention will become apparent from the following description, given by way of example only and with reference to the accompanying drawings in which:

FIG. 1 is a diagrammatic top perspective view of an apparatus for singularising clustered fruit, in accordance with one embodiment of the present invention; and

FIG. 2 is an enlarged top perspective view of the channel of the singularising/declustering embodiment of FIG. 1, in accordance with that embodiment of the present invention: and

FIG. 2A is an enlarged diagrammatic top perspective view of the singularising/declustering embodiment of FIG. 2, in which a cutaway section more closely illustrates the location of drive mechanisms for the cutting means relative to the channel bed, in accordance with that embodiment of the present invention; and

FIG. 3 is a diagrammatic top perspective view of the channel portion of the singularising/declustering apparatus, in accordance with an embodiment of the present invention; and

FIG. 3A is a diagrammatic top perspective view of the singularising/declustering apparatus, in accordance with the embodiment FIG. 3, of the present invention; and

FIG. 4 is a diagrammatic side view of the general configuration of one undulation of the singularising/declustering apparatus, in accordance with one embodiment of the present invention; and

FIG. 5-5C are diagrammatic side views of cutting means of the present invention arranged relative to and with reference to a single undulation of the singularising/declustering apparatus, in accordance with various possible embodiments of the present invention; and

FIG. 6A is a diagrammatic perspective view of one example of possible alternative driving means for use with the cutting means of the singularising/declustering apparatus, in accordance with another embodiment of the present invention; and

FIG. 6 is a diagrammatic side view of one example of possible driving means for use with the cutting means of the singularising/declustering apparatus, as exampled in relation to the embodiment of the cutting means of FIG. 5, in accordance with but one possible embodiment of the present invention; and

FIGS. 7-7C are diagrammatic side views of cutting means, of FIG. 5, illustrating unengaged and engaged cutting means, for singularising/declustering apparatus, in accordance with one operational example of one embodiment of the present invention; and

FIGS. 8-8C are diagrammatic side views of cutting means, in relation to another embodiment of cutting means, illustrating unengaged and engaged cutting means, of the singularising/declustering apparatus, in accordance with another operational example of another embodiment of the present invention; and

FIGS. 9-9B are diagrammatic side views in relation to exampled variations in the configuration of cutting means of FIG. 5, of the singularising/declustering apparatus, in accordance with other possible embodiments of the present invention; and

FIGS. 10-10B are further diagrammatic side views in relation to exampled variations in the configuration of cutting means of the singularising/declustering apparatus, in accordance with other possible embodiments of the present invention; and

FIG. 11 is a diagrammatic side view of one embodiment of locator means for use in conjunction with cutting means for singularising/declustering apparatus, including cutting means, in accordance with another embodiment of the present invention; and

FIG. 11A is a diagrammatic side view of part of the drive means for use in conjunction with locator means of FIG. 11, for singularising/declustering apparatus, including cutting means, in accordance with another embodiment of the present invention; and

FIGS. 12-12A are diagrammatic top perspective views illustrating alternately configured cutting means, for singularising/declustering apparatus, in accordance with other embodiments of the present invention; and

FIG. 13 is a diagrammatic side view illustrating alternately configured locator means, for singularising/declustering apparatus, in accordance with another embodiment of the present invention; and

FIG. 14 is a diagrammatic side view illustrating alternately configured locator means, for singularising/declustering apparatus, in accordance with another embodiment of the present invention; and

FIG. 15 is a diagrammatic side view illustrating alternately configured locator means, for singularising/declustering apparatus, in accordance with another embodiment of the present invention; and

FIGS. 16-16C are diagrammatic views of the configuration of guiding means to assist the directional flow of clustered fruit, in accordance with other embodiments of the present invention: and

FIGS. 17-17A are diagrammatic views of the configuration of guiding means to assist the directional flow of clustered fruit, in accordance with another embodiment of the present invention; and

FIGS. 18-18I are diagrammatic views of the configurations of guiding means to assist the directional flow of clustered fruit, in accordance with other embodiments of the present invention; and

FIGS. 19-19D are diagrammatic side and/or top perspective and/or top plan views of examples of a range of possible alternate configurations of cutting means arranged on and in relation to a single undulation and multiple undulations along a channel of singularising/declustering apparatus, in accordance with a range of other embodiments of the present invention; and

FIGS. 20-20A are diagrammatic cross-sectional views exampling fluid flows along a channel and undulations within the channel of singularising/declustering apparatus, to demonstrate the directional flow of clustered fruit, along the channel in accordance with another embodiment of the present invention; and

FIG. 21 is a diagrammatic top perspective view of the singularising/declustering invention, illustrating an optional feed-in system and multiple channel arrangement in accordance another embodiment of the present invention.

### BEST MODES FOR CARRYING OUT THE INVENTION

With reference to the present invention by way of example only, there is provided apparatus for singularising clustered fruit.

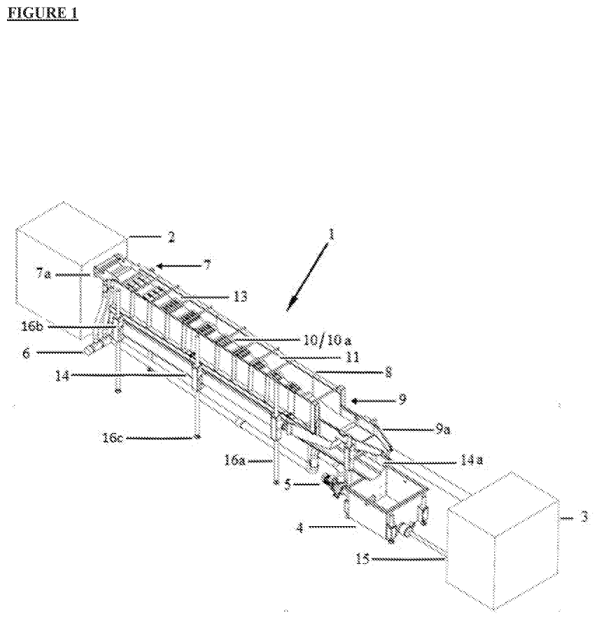

As illustrated in FIGS. 1-3A, said apparatus is generally indicated by arrow 1. FIG. 1, provides one diagrammatic representation of one possible embodiment of the singularising/declustering apparatus of the present invention where the apparatus is presented in a manner where it has the potential to form part of a greater fruit processing operation; and, where the fruit processing operation is undertaken in stages via a series of additional in-line apparata that may be attached to and/or be associated with the invention; and, where the singularising/declustering apparatus is relevant to an early stage of the said processing after the clustered fruit has been harvested, but where the harvested clustered fruit is subsequently required to be singularised prior to the fruit being graded and packaged for market.

Accordingly, therefore, in relation to the apparatus for singularising clustered fruit (1), where the singularising/declustering invention (1) is part of a more complex, in-line, processing operation, the invention may require that there be an upstream stage (which may be mechanised, or not) where the harvested clustered fruit is loaded/presented onto or into the singularising/declustering apparatus in order for the fruit to be processed and singularised/declustered. In FIG. 1, this upstream configuration is represented schematically as a fruit-loading machine (2). Said upstream fruit-loading machine (2) may ensure that the clustered fruit is appropriately presented, carried to, or delivered in to, the declustering apparatus (1). In some applications, this stage may be undertaken manually rather than being mechanised/automated.

In addition, in systems where the singularising/declustering invention (1) is part of a more complex, in-line, processing operation, the present apparatus may also be used in conjunction with additional apparatus relevant to at least one downstream stage (which may be mechanised, or not), with the downstream apparatus being designed and operated to undertake additional stages independent of and following the singularising/declustering of the fruit.

As such, these additional stages may include quality control operations (including inspection and grading for ensuring preferred colour, size, firmness, state and presentation of the fruit) and packing operations, and so forth. Accordingly, in FIG. 1, the configuration of the downstream machinery (undertaking these on-going functions) is simply represented schematically at (3).

While FIG. 1 is presented to generally allude to and demonstrate one possible example of a processing line with and within which the invention may be employed. FIG. 1 also broadly presents one configuration of the singularising/declustering apparatus of the present invention.

Accordingly, having regard to FIG. 1, the components and features of the invention broadly are illustrated to include a reservoir (4) for holding a fluid (not shown): pumping means (5) for pumping the fluid via at least one fluid supply conduit/line (6) towards an inlet (generally indicated at 7/or by arrow 7), said inlet located at the forward end of the invention where the fluid is presented into the singularising/declustering apparatus. The inlet (7) also includes an inlet attachment (7a) that typically coincides with the entry of loaded fruit in to the singularising/declustering apparatus.

It should be appreciated that either or both the reservoir and the pump means (5) may be readily available, off the shelf systems, or may be specifically configured for use with the present invention.

The singularising/declustering apparatus also includes a channel (8) and, it is along this channel that the fluid directionally flows. At this stage, the fluid contributes the motive means to transport the clustered fruit along and/or down the channel (8) from the inlet (7) of the channel towards an outlet (generally indicated by arrow 9) of the channel, at the end of the channel (8). The outlet (9) of the channel also including an outlet attachment (9a), adapted to funnel and/or direct flowing fluid exiting the Channel 8. Said outlet attachment also presents the singularised/declustered fruit for subsequent removal, or transfer to any subsequent in-line processing apparatus that is employed to check the fruit for quality and preferred characteristics and/or direct the fruit to an area for packing the fruit.

The channel (8) includes a base (10) and side portions (11). The base (10) has an upper face and a lower face In FIGS. 1-3A, the channel (8) is substantially U-shaped/U-shaped. However, this shape should not be seen as the only possible configuration of the channel. Rather, it is merely illustrative of one embodiment of the present invention and should therefore not be seen as limiting the present invention.

In various embodiments of the present invention, (as shown in FIG. 1), the upper face (10a) of the base (10) that is within the channel, essentially also operates as the bed of the channel. Accordingly, the base bed (10a) of the channel of various embodiments may be configured to be substantially horizontally aligned. However, in other embodiments of the present invention, the base bed (10a) of the channel may be angled/sloping; and/or, in yet other embodiments of the present invention, the base bed (10a) of the channel may be substantially undulating.

In addition to the base (10), in some embodiments there may also be e a separate bed (12 not shown in FIG. 1) that is not only separate to but distanced from (above) the base (10). Similarly, the bed (12) may be configured to be substantially horizontally aligned. However, in other embodiments of the present invention, the separate bed (12) of the channel may be angled/sloping; and/or, in yet other embodiments of the present invention, the separate bed (12) of the channel may be substantially undulating.

FIGS. 1-3A illustrate one embodiment of the present invention configured to include both a base (10) and a separate bed (12). In this embodiment, the bed (12) is distance vertically above the base (10). The bed (12) is further configured to be attached to/secured to the side portions (11) of the channel (8). In addition, according to the embodiments of FIG. 1-3A, located along either or both the length of the channel (8) and, across the width of the channel (8), there are cutting means (13). Said cutting means (13) are preferably positioned and configured to singularise the clustered fruit by severing the joining points/knuckles/abscission zones which retain the individual fruits joined together within the cluster.

As also illustrated in FIGS. 1-3A, there is also at least one outlet (9) located at the distal end of the channel (8). The outlet (9) of the singularising/declustering apparatus is where the fluid exits the channel (8) carrying the singularised/declustered fruit.

In one embodiment of the present invention, in the vicinity of the base (10) there is also fluid collection means (14) adapted to collect fluid spilt along and from the channel/bed (10a/12). In some embodiments of the present invention, the fluid collection means is, and/or operates as, a drip tray (14). Said fluid collection means or drip tray (14) directs spilt fluid collected therein, towards the outlet (9) of the channel, where it is returned to the fluid reservoir (4), via a drip tray drain (14a) included within, or attached to, the fluid collection means (14).

In addition, in the embodiments of FIGS. 1-3A as illustrated herein, there is also, in the vicinity of the outlet (9) of the channel (8), fluid recirculation means (15) included for use with the present invention.

The fluid recirculation means (15), relevant to the present invention, may be incorporated into the apparatus, or it may be attached to the apparatus or it may be distanced/separated therefrom. The fluid recirculation means (15) is preferably designed and operated to undertake an additional stage in the functionality of the present invention, following the singularising/declustering of the fruit. Accordingly, said fluid reticulation means (15) ensures a consistent, steady, suitable (in terms of quality) and adequate supply of fluid for the on-going operation of the singularising/declustering apparatus.

Said fluid reticulation means (15), therefore, preferably incorporates filtering means (not shown) to remove debris and/or contaminants from the fluid used with the present invention, to ensure the fluid is able to be freely delivered into the channel (8) without concerns of blockages due to debris; and, without concerns that debris or fluid contaminants may damage the fruit being processed. Said recirculation means (15) and said fluid collection means (14) are both adapted to return fluid collected therein and/or conveyed thereby, to the fluid reservoir (4), thereby enabling both a constant recirculation of the fluid through the singularising/declustering apparatus and maintaining the quantity and/or quality of fluid required for the process.

The embodiment illustrated in FIGS. 1-3A also includes a frame (16). The frame (16) supports the singularising/declustering apparatus at a height above the ground/a surface that is suitable either for the manual input of the clustered fruit at the input of the channel; and/or enables the singularising/declustering apparatus (1) to be oriented to position and configure the apparatus to complement upstream and/or downstream apparata that collectively form an in-line processing chain from the input of harvested fruit clusters through the stages of singularisation, quality control, sorting and packaging stages, for example.

The frame (16) of the embodiments of FIG. 1 may operate as either a stand-alone frame on which the singularising/declustering apparatus is positioned and/or secured; or, a physically integrated frame that contributes to the operational configuration of the apparatus. The frame (16) may include legs (16a) to position and support the singularising/declustering apparatus above the ground/surface. In addition, the legs may include optional height adjustment means (16b) to enable better vertical positioning and/or alignment of the apparatus. Each leg further includes a base (or foot (16c)) that is adapted to stabilise the apparatus relative to the surface on which the apparatus is standing. The base (or foot (16c)) may also be configured to allow the machine to be bolted to the floor if desired.

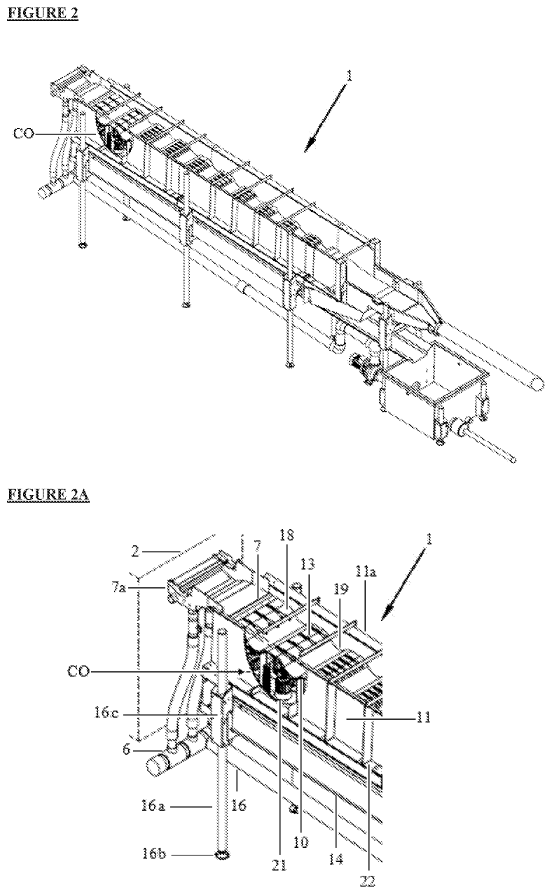

FIG. 2 is a substantially truncated top perspective view of the present invention, in which the singularising/declustering apparatus is presented as a stand-alone option, without upstream and/or downstream apparatus that would be used in an otherwise in-line processing chain.

Within FIG. 2 there is included a cut-out portion (CO) on the side of the singularising/declustering apparatus, in the vicinity of the input into the channel (8). As may be seen in an enlargement of the cut-out portion, illustrated in FIG. 2A, the bed (12) is raised up and above the base (10) of the apparatus. It can be further observed, that the bed slopes downwards from the location of the inlet (7) of the channel towards the location of the output/exit (9) of the channel.

In addition, it can be seen that the bed includes undulations (17) that start at the input (7) into the channel (8) and continue along the length of the channel towards the location of the output/exit (9) of the channel. These undulations are substantially wave-like in configuration—each undulation being comprised of a wave crest (18) and a wave trough (19).

FIG. 2A further illustrates that positioned on/in and across each wave crest (18), there are cutting means (13). In accordance with various embodiments of the present invention, each crest may include at least one cutting means. In relation to the embodiment illustrated and exampled in FIG. 2A, there are multiple cutting means arranged on/in and across each wave crest of each undulation.

In addition, having regard to the cut-out portion, it can be seen that beneath the bed and in the area below the wave crest of an undulation (corresponding to the location of the cutting means) and on or above a separate base (10) of the channel, or, on or within the drip tray (14), there is a cavity (20). For the purpose of the present invention, the term ‘cavity’ shall mean and describe a substantially empty, enclosed space or chamber, defined between the separated bed (12) of the channel (8) and the base (10) of the channel; or, between the separated bed (12) of the channel (8) and the drip tray (14).

In relation, to the embodiment of FIG. 2A, the cavity includes at least one additional feature. For the purpose of the present invention, that feature is a stylised representation of a driving mechanism (21) designed for use with, or adapted for use with, the present invention. The said driving mechanism may be used with/adapted for use with various configurations of the cutting means, to facilitate the cutting action required to separate the clustered fruit at the joining point/knuckle/abscission zone of the cluster.

In the present embodiment of FIG. 2A, the driving mechanism (21) is therefore located relative to the cutting means (13) and as such would be configured to drive the movement of the cutting means as a whole or any part thereof.

While the embodiment of FIG. 2A illustrates the location of a single driving mechanism (21), it should be appreciated that there may be multiple driving mechanisms located beneath the bed (12) of the singularising/declustering apparatus. However, in variations to the embodiment, the driving mechanism may not necessarily be fully beneath the bed. For example, at least the motor and gear reduction may likely be located “outside” the side panels of the apparatus, so that water will not drip onto the motors of the driving mechanism(s) (12).

The said driving mechanisms (12) may be used to drive moveable parts of a single cutting means (13): or, a single driving mechanism (12) may be used to drive the moveable parts of multiple cutting means (13). In addition, the driving mechanism operates the cutting means at a speed to enable the cutting means to quickly and easily cut through the joining point/knuckle/abscission zone of the clustered fruit, to enable the individual fruit to be separated from the cluster in a clean, precise manner such that the fruit retains its own stalk intact, and there are no hooked or partial stalks and damage to the fruit is preferably avoided.

Depending on the specific embodiment of the present invention and the cutting means employed with the invention, the driving mechanism may operate as a variable speed driving mechanism (in which a change in the speed can be easily effected), or as a constant speed driving mechanism, or as a sporadic or intermittent driving mechanism. Any suitable driving mechanism that may be available within the prior art, may be used with, or adapted for use with the present invention. Alternatively, the driving mechanism may be specifically designed for use with the invention. In all instances, the driving mechanism is preferably simple in construction and reliable in operation.

In other embodiments of the present invention without any driving mechanism(s), the cutting means may otherwise be configured to passively cut through the joining point/knuckle/abscission zone of the clustered fruit. In such embodiments, the cutting means will preferably be configured to enable it to slice or shear through the joining point/knuckle/abscission zone of the clustered fruit, and again enable the individual fruit to be separated from the cluster in a clean, precise manner such that the fruit retains its own stalk intact, and there are no hooked or partial stalks and damage to the fruit is preferably avoided.

However, it should also be appreciated that in terms of the operation of the apparatus, (in some circumstances) a passive cutting mechanism may not be practical, particularly where the force required to slice or shear through the joining point/knuckle/abscission zone of the clustered fruit, might unfavourably cause or result instead in the stem being pulled out of the fruit.

In such embodiments, the cutting means may be configured to slice, shear, or saw through the joining point/knuckle/abscission zone of the clustered fruit. This may be effected as a result of a combination between the forces of the fluid against the clustered fruit causing the fruit to be pushed/dragged along the cutting means, the weight of the clustered fruit causing the fruit to engage with and pull down on the cutting means, and the sharpness of the cutting means and the configuration of the cutting means contributing to the fruit being held in place until the joining point/knuckle/abscission zone of the clustered fruit is cut through.

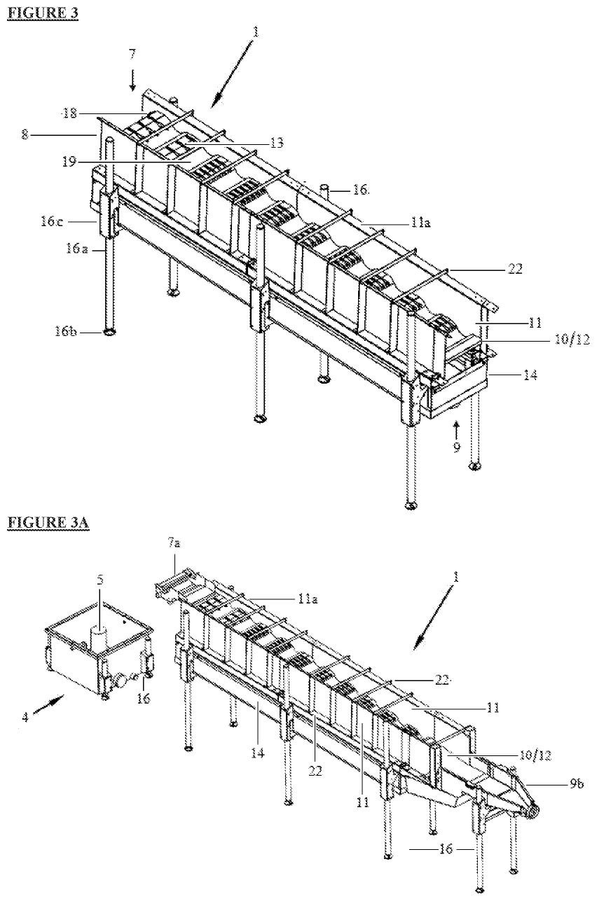

In the embodiment of FIGS. 3-3A, the top perspective view better illustrates an enlarged view of the stem singularising/declustering section (1a) only.

Accordingly, the embodiment again includes a supporting frame (16) with height adjustable legs (16a). In addition, as with FIGS. 1-2A, the channel (8) includes a base (10) and side panels (11). Further, the channel includes a bracing system (22) that serves to connect and/or strengthen and/or reinforce and/or stabilise the side panels relative to the base, to minimise any negative effects of pressures applied to the side panels by the fluid pumped through the channel, and/or from internal structural features that might otherwise cause the side panels to deform or bow laterally outwards.

In addition, the bracing system (22) will similarly reinforce/strengthen the base and/or the position and slope of the bed relative to the side panels. Therefore, the bracing system is relevant or potentially relevant in embodiments where the side panels and/or the base and/or the bed of the channel are comprised of multiple individual sections joined together to produce an elongate section of the desired length and/or width and configuration required for the channel (8). The presence of bracing means (22) may be dictated by the materials from which the channel (8) is constructed. For example, where the channel is manufactured from thermoplastic materials, the bracing means may be more substantial. However, where the channel (8) is manufactured from metal (and preferably stainless steel as typically used in the manufacture of a large range of machines and apparata used in the food industry), then, bracing means (22) may or may not be employed.

In some embodiments of the present invention, the channel may be moulded/constructed as a single unit of desired width and length. However, it should be appreciated that a single unit would also benefit from being able to be supported and strengthened along its length via a bracing system. However, in some situations where it may be desirable to adjust the width and or length of the channel to accommodate the singularising of different fruit, different throughput/capacity, manufacturability and/or to configure the apparatus to match a particular packhouse layout and/or processes, a channel that is comprised of separate units that may be interconnected, or adjustable may be preferred and bracing means may be employed to provide additional strength to the channel.

One possible embodiment of an arrangement where at least the side portions (11) of the channel (8) may be comprised of sections connected together is more clearly exampled in FIGS. 3-3A.

It is to be further appreciated that the length and width of the channel is preferably determined to be sufficient to enable a preferred quantity of clustered fruit to be singularised during a single pass through the apparatus.

In addition, therefore, the number of undulations (17) arranged along the channel (8) needs to optimise the singularising of the clustered fruit. Accordingly, the length and width of the channel (8) and the number and arrangement of the cutting means (13) may be determined by a number of factors, not the least being the type of fruit and the size of the fruit (and the fruit clusters). As illustrated in FIG. 3, there are ten undulations (17) and each undulation includes three or more cutting means (13), with the number of cutting means per undulation increasing along the length of the channel (8).

In addition, one preferred embodiment as illustrated in FIGS. 3-3A is configured to include a sloping bed (12). The bed (12) is adapted to slope downwards to assist the clusters of fruit flow down the channel (8), where they come into contact with the cutting means (13).

In other embodiments of the present invention (not shown), the base (10) may also slope downwards. The angle of slope of the channel (8) is preferably between 2 degrees and 15 degrees. However, the optimum slope is preferably around 6.5-7 degrees. Slope angles may, however, vary in relation to other embodiments of the invention.

Therefore, having regard to the embodiments as illustrated in FIGS. 1-3A, the length of the channel (8), the flow rate of the fluid, the slope of the bed (12)/base (10), the number and width of the undulations (17) and the location and number of the cutting means (13) are preferably optimised to effectively process the singularising of the clustered fruit.

In yet other embodiments (not shown) where the channel and slope of the base/bed may need to be longer and/or steeper, the height of the undulations at the beginning of the channel may need to be initially higher than might need to be the case for a shorter and potentially shallower channel.

Accordingly, where the height of the undulations and/or the slope of the undulating bed/base need to be greater, then, in turn, the channel sides may also need to be higher to avoid, or minimise, the fluid/water within the channel overflowing the sides of the channel.

It is to be also to be noted that the channel of the singularising/declustering apparatus (as illustrated in FIGS. 1-3A) is open at the top. This is advantageous in the event of needing to clear any build up or blockages created by fruit clusters being caught and/or retained at locations along the channel. It may be common within the industry that a tool (not shown) is used to attempt to loosen the clusters and correct any blockages. However, (while not recommended because of the presence of the cutting means) there is also the potential that an individual may manually attempt to unblock the channel.

It should be appreciated that a channel opened at the top is not intended to limit the scope of the present invention to such embodiments. Accordingly, embodiments in which a cover, and/or guard and/or or shield (such as exampled at 11a) are employed, are also possible within the ambit of the present invention. For example, in some embodiments the height of the channel sides may need to be adapted and any one or more of a shield, guard and/or top (not illustrated) may be employed to minimise the likelihood of an individual having easy or ready access to the interior of the channel, where it is a prudent, given the arrangement of cutting means across and along the channel, that an individual's access to the interior of the channel be minimised to limit or reduce the likelihood of an individual being injured by being easily able to come in to contact the cutting means, particularly where the cutting means may be moveable, and/or include a sharpened surface.

The cover, guard and/or shield (such as, in part, exampled in FIG. 3 (at 11a) may be manufactured from any one or more (in combination) of metal, thermoplastic materials, rubber, glass and wood. The cover, guard and/or shield (11a) may be manufactured in sections and attached to the side portions (11) of the channel (8), as more clearly shown in FIG. 3. Alternately, some form of a shield and/or guard may be integral to the channel where the channel is manufactured/moulded from a single length and width of material.

In addition, the cover, guard and/or shield may include sections (not illustrated) which may be configured, spaced and positioned along the length of the cover, guard and/or shield. Said sections may be further configured as a pivotable, and/or removable hatch or flap (or take any other suitable configuration) that may be opened and closed. The hatch and flap may be dimensioned to enable access to the channel for cleaning and/or maintenance purposes when the singularising apparatus is not in use. In addition, the hatch and flap may be further configured such that when the singularising apparatus is operational, only limited access in to the channel is possible for the purpose of using a tool (not shown) in situations where it is necessary to loosen the clusters and/or correct any blockages, but that the access is not sufficient to enable an individual to put a hand and/or an arm into the channel while the singularising apparatus is operational. Accordingly, restricting means (not illustrated), (such as locks) and/or electronic monitoring and alarm systems may be employed with the invention in order to minimise access in to the channel by individuals at times when it is not safe to do so.

As with the embodiment of FIGS. 1-2A, the arrangement of the inlet (7), the outlet (9), the undulating bed (12) and the drip catching tray (14), can be clearly seen in FIGS. 3-3A. In addition. FIG. 3A includes additional features of a diagrammatic illustration of a reservoir means (4), used with or adapted for use with the present invention. Said reservoir means includes a pump means represented at (5). It should be, however, appreciated that any suitable pumping system may be associated with the reservoir and used with or adapted for use with the present invention.

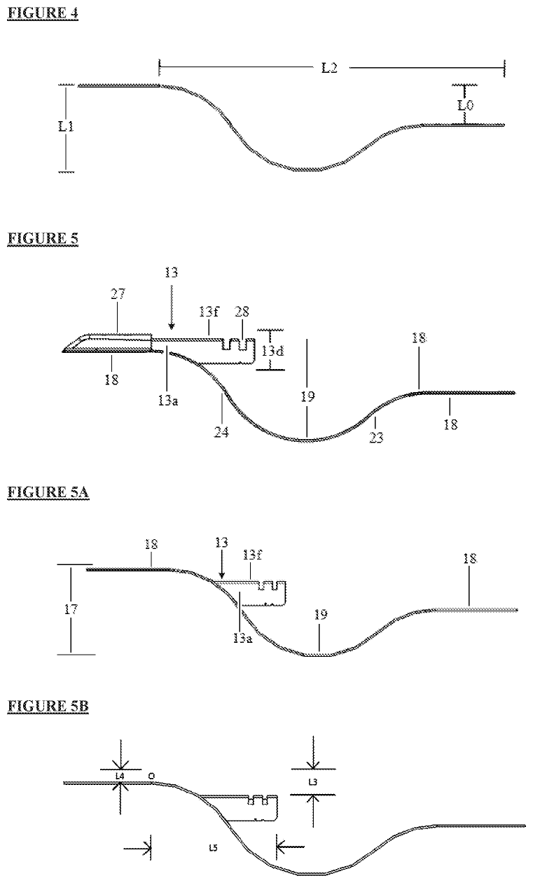

In relation to the present invention, FIG. 4 illustrates one example of a configuration of a single undulation (17) of the base (10)/bed (12) of the invention of FIGS. 1-3A. As can be seen, the undulations (17) are wave like. In relation to a typical wave, the wave is comprised of a forward wave slope (23), a wave crest (18) and a trailing wave slope (24), followed by a wave trough (19). However, FIG. 4 illustrates the undulation (17) from the perspective of a single wave trough (19) between two adjacent wave crests (18). This is because the wave trough (19) is an important feature of the present invention and relevant to the operation of the invention.

Accordingly, in FIG. 4, in one embodiment of the invention, the vertical distance from the top of the forward crest (18) to the trough base (19B)—is illustrated at L1. In one embodiment of the invention, this distance is between 80-100 millimetres in height. In addition, the distance between the central point of the peak of the first wave crest and the central point of the peak of the second wave crest is representative of the wave length. It is illustrated at L2 and in the embodiment illustrated the wave length is preferably, 392.3 millimetres (plus or minus 60 millimetres). The dimension illustrated at L0—denotes a vertical drop between the height of the first wave crest and the height of the second wave crest of 45 millimeters (plus or minus 20 millimetres).

Accordingly, it can be noted from the embodiment of the invention as illustrated by FIG. 4, the base/bed of the channel is configured such that the crest (18) of a forward wave is higher than the crest (18) of a subsequent wave, thereby effecting a slope in the configuration of the bed/base of the channel. The ensuing slope thereby assists the flow of the fluid down the channel and over the undulations, facilitating the travel and progress of the clustered fruit from the inlet of the channel, to the outlet of the channel.

It should be appreciated that FIG. 4 illustrates but one possible embodiment of the present invention. The undulation, illustrated in FIG. 4, is therefore, provided to contribute to a broad description of the invention and should not be seen as limiting the invention to only this illustrated example.

Accordingly, any one or more of the distances from the top of a forward crest to the subsequent trough base; and/or the dimensions of the wavelengths; and/or the vertical drops between the height of a forward wave crest and the height of a second wave crest may vary, as required or desired, to meet and or complement specifications and/or the operational performance of alternate embodiments of the invention.

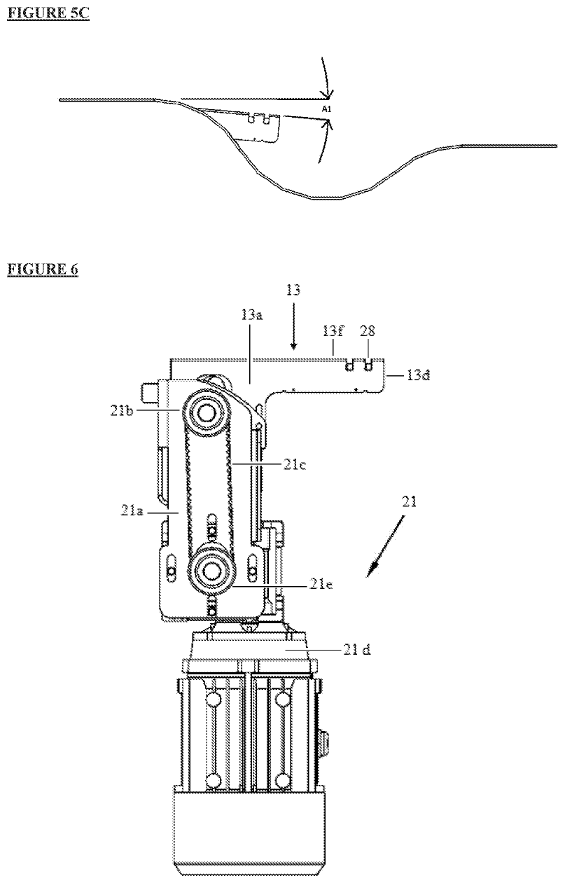

Having regard to the exampled embodiment of the invention as illustrated in FIGS. 1-3A. FIGS. 5-5C further illustrate various features of the cutting means (13) employed with, and/or used in the invention.

Accordingly, FIG. 5 illustrates one possible configuration, location and orientation of a cutting means (13) of the present invention with reference to an undulation (17) of the base (10)/bed (12) of the channel (8) of the singularising/declustering apparatus. In FIG. 5, the cutting means (13) is configured to extend in a substantially horizontal plane from a location on the top of the undulation wave crest (18) and project forward to extend over and above the face of the trailing wave slope (23) of the wave and thereby be suspended over and above at least a portion of the subsequent trough (19) of the undulation (17). FIG. 5 also illustrates that the cutting means (13) is substantially elongate such that it is a first distal end (25) of the cutting means (13) that is positioned on/in the wave crest (18) and, a second distal end (26) that is projected over the trailing wave slope (24) of the undulation (17) and suspended above the trough (19) of the undulation (17).

In addition, the cutting means (13) of FIG. 5 includes a housing (13a) and a blade portion (13b). The cutting means (13) of FIG. 5 also includes, a cover (27). Said cover (27) may be a component of any housing (13a) associated with the cutting means (13), or may be additional to any housing (13a) employed with the cutting means. Said cover (27) preferably envelops and/or surrounds a portion of the first distal end (13c) of the cutting means (13).

In such embodiments, the cover (27) is/or may be adapted so that the clustered fruit, being carried along and down the channel (8) by the fluid, is protected from contacting any portion of the blade portion (13b) of the cutting means (13) that might cause damage to the fruit and/or cause the clustered fruit to catch on the first distal end of the cutting means (13a) and thereby be held/retained/prevented from progressing down and along the channel. In addition, or alternately, the cover (27) may be configured to contribute to/facilitate with guiding the clustered fruit over the undulation/wave crest (18) and/or with positioning the clustered fruit in-line with the cutting means (13) and/or assist with orienting the clustered fruit, in order to facilitate and increase the likelihood that the clustered fruit is appropriately exposed to a preferred portion of the cutting means (13), such as the blade portion (13b) that is responsible for cutting/slicing/shearing/saving through the joining point/knuckle/abscission zone of the clustered fruit in order to effect singularising of the clustered fruit.

Having regard to FIG. 5, FIG. 5B illustrates another possible embodiment of the present invention in which the first distal end (13c) of the cutting means (13) is configured to be inserted into the trailing wave slope (24) of the wave/undulation (17). Again, the cutting means (13) is configured to extend in a substantially horizontal plane from the undulation/wave (17) and project forward over and above the trailing wave slope (24). Accordingly, the second distal end of the cutting means (13d) is again thereby suspended above at least a portion of the subsequent trough (19) of the undulation (17).

In this embodiment, the body of the cutting means (13) is configured such that the joining point/knuckle/abscission zone of the clustered fruit, is able to be caught by the cutting means as the cluster is carried over the wave crest (18) of the undulation (17) by the fluid, the cluster is therefore, again, able to be thereby held/retained/prevented from progressing down the trailing wave slope (24) of the undulation/wave (17) and in to the trough (19) of the wave.

In addition, the weight of the fruit of the cluster and the flow of the fluid may cause the fruit to be positioned on/over the cutting means (13), such that the fruits hang down over the sides of the cutting means. This configuration is therefore, again, able to facilitate and increase the likelihood that the joining point/knuckle/abscission zone of the clustered fruit, is appropriately exposed to a blade portion (13b) of the cutting means (13) that is responsible for cutting/slicing/shearing/sawing through the joining point/knuckle/abscission zone of the clustered fruit in order to effect singularising of the clustered fruit.

With reference to FIG. 5B, it can be seen that the cutting means (13) may be adapted to be adjusted. Such adjustments may include vertical and/or horizontal adjustments. For the purpose of illustrating this feature of the present invention, the location of the first distal end of the cutting means (25) (of the part of the cutting means inserted within the wave crest) is indicated at (O). In addition, for the purpose of illustrating this feature of the present invention, the point at which the cutting means (13) extends from the trailing wave slope (24) of the wave/undulation (17) is indicated at (O-1). Further, the potential vertical adjustment range is represented at L3; and, the horizontal adjustment range is represented at L5. In this embodiment, the potential maximum height the cutting means (13) is able to be adjusted vertically, above the wave crest (18) is the height as determined from datum L4. L4 being the point which serves as the reference or base for the measurement of the vertical adjustment above the wave crest (18).

As an example of said vertical and/or horizontal adjustments, the vertical adjustment range in one embodiment may be 27 millimetres; and, the horizontal adjustment may be between 110-165 millimetres. In this example, the maximum height of the cutting means from the datum may be in the vicinity of around 10.5-17 millimetres.

Having regard to the above example, FIG. 5C represents the potential for angular adjustment of the cutting means (13). Accordingly, the angular adjustment potential in this embodiment is represented at AI. This is a tilt of the cutting means (13) between 0 degrees (horizontal) and 5 degrees (angled downwards). Alternately, if preferably set at true horizontal, there may be no provision or desire for angular adjustment.

While the above description is provided by way of example, to illustrate one possible configuration, it should be appreciated that the example should not be seen as limiting the scope of the present invention and that in other embodiments of the present invention such adjustable cutting means and the range and direction of adjustment may be differently configured. Such alternatives may be dependent on the configuration of the cutting means, where the cutting means may not be linear, but may be circular, and so forth.

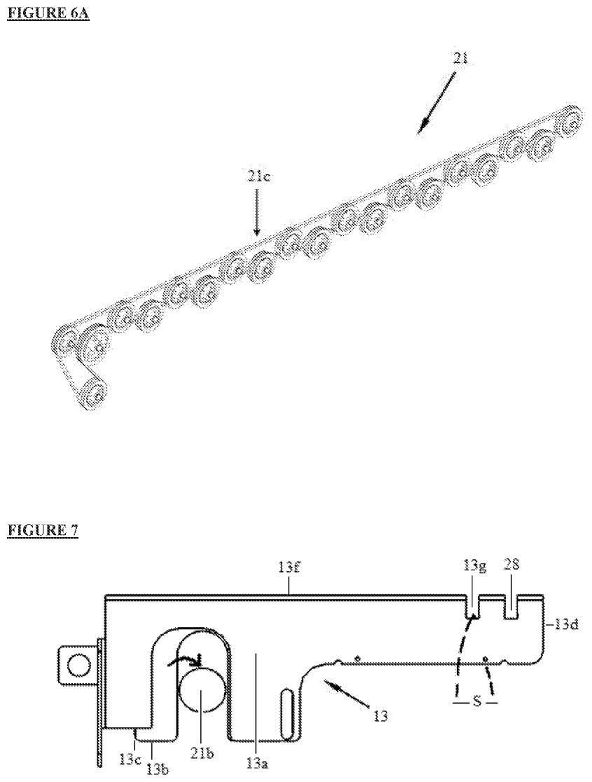

With reference to the cutting means described above, as illustrated in FIGS. 5-5C. FIG. 6 illustrates one possible embodiment of a driving mechanism (21) that is included with at least one cutting means (13). Said cutting means (13) including a housing (13a) and a blade portion (13b) and said blade portion (13b) includes at least one cutting edge (13e). Said driving mechanism (21) also including a frame (21a), said frame supporting a camshaft (21b) and cam belt (21c); along with a drive shaft (21d) and a motor (21e).

However, whilst FIG. 6 illustrates an embodiment of a driving mechanism (21) for use with the invention, it should be appreciated that this is but one possible example. Accordingly, an alternative and/or an alternatively configured driving mechanism may be used with, or adapted for use with, the invention. For example, FIG. 6A offers an alternate system whereby instead of one motor per bank of cutting means (13) as shown in FIG. 6, an option such as that of FIG. 6A illustrates the use of a single motor with belts to drive multiple banks of the cutting means (13).

Again, whilst FIG. 6A offers another alternative driving mechanism for use with the invention, it should still be appreciated that this is but one other possible example. Accordingly, any suitable alternative and/or any alternatively suitably configured driving mechanism may be used with, or adapted for use with, the invention.

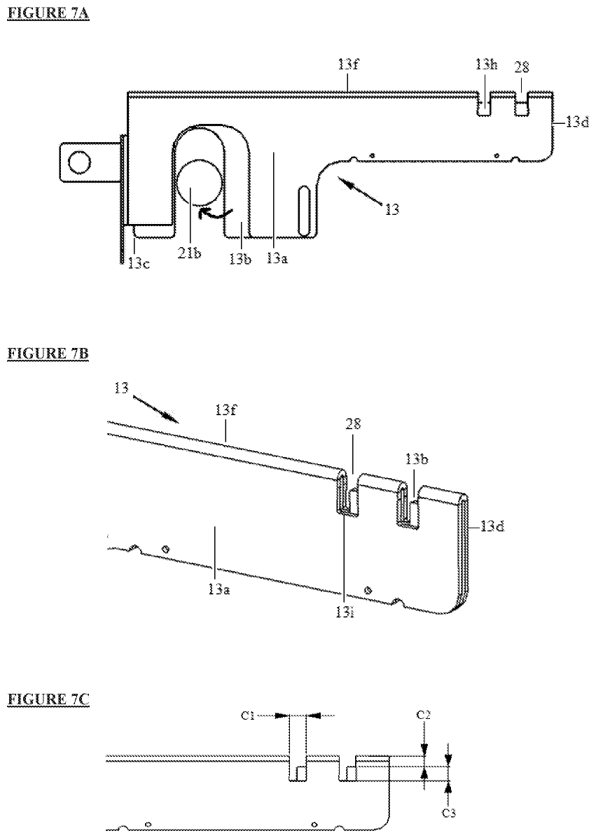

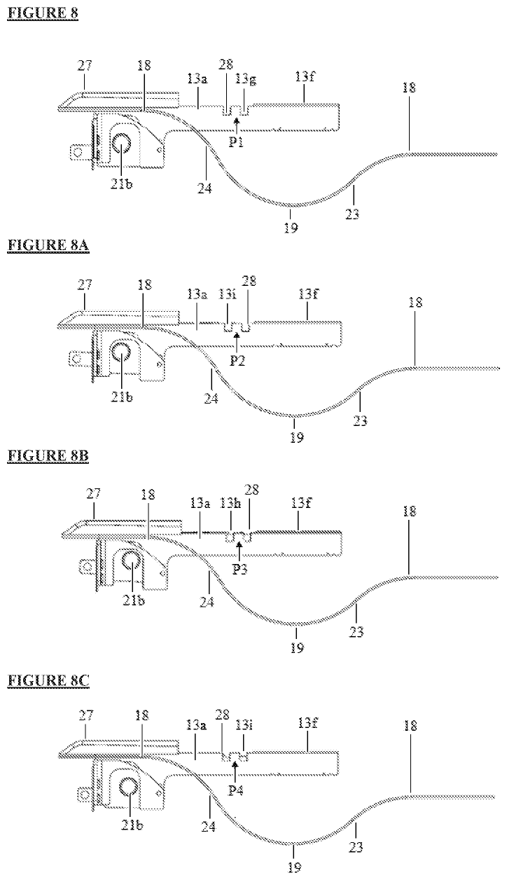

With reference to the driving mechanism described above, as illustrated in FIG. 6, FIGS. 7-7C and FIGS. 8-8C illustrate examples of the way the cutting means (13) may be operated by the said driving mechanism (21) used with or adapted for use with the invention. FIG. 8 illustrates the drive mechanism effecting Position P1 where the cutting means is opened to receive a fruit cluster. FIG. 8A is a partially Position P2 where the blade portion becomes evident. FIG. 8B is where the blade portion becomes fully presented—P3. FIG. 8C is where the blade portion is again returning to a partially presented position—P4.

It should, therefore, be appreciated that the driving mechanism (21) selected for use with the invention may dictate variations in and to the operation of the cutting means (13). Therefore, the embodiments of FIGS. 7-8C should not be seen as the only possible examples and additional variations may constitute further workable examples within the scope of the present invention.

In the embodiment as illustrated in FIG. 7, the cutting means (13) is adapted to include a body (13a) and at least one blade portion (13b). The blade portion (13b) may be fixed (unmoveable), or moveable. The blade portion (13b) also includes at least one cutting edge (13e). The cutting edge (13e) may be blunt or sharpened. The body (13a) of the cutting means (13) includes and/or operates as housing (13a) for the blade portion (13b). In addition, the body (13a) is adapted to include arrestor means (28). The arrestor means (28) are designed to temporarily stop, capture, hold and/or retain the clustered fruit as the clustered fruit is carried over the wave crest (18) of an undulation (17) and prevent the clustered fruit from being taken further down the channel (8) by the flow of water. In addition, the arrestor means (28) is designed to present the joining point/knuckle/abscission zone of the fruit cluster at a location where the blade portion (13b) of the cutting means (13) may operate to cut, slice, shear, or sever the connection between the individual fruits at the collective joining point/knuckle/abscission zone.

The arrestor means (28) of the embodiment exampled by FIG. 7 is represented as an indentation (notch (28a)) in the upper edge/surface (13f) of the housing (13a) of the cutting means (13).

In FIG. 7, there are two notched arrestor means (28a). In the first arrestor means, there are a series of dashed lines (at S) representing the stalks of a cluster of two fruits, where the stalks hang down each side of the housing body (13a) of the cutting means (13). This positioning typically retains the joining point/knuckle/abscission zone of the cluster in an alignment that is preferred for effecting the singularising of cluster of fruit.

Also, in the example illustrated by FIGS. 7-7B, the housing body (13a) operates as a sheath that substantially encloses the blade portion (13b) when the blade portion (13b) is not in an operational cutting configuration, and yet enables the blade portion (13b) to move within the housing body (13a) such that the blade portion (13b) may be presented from a covered (sheathed), non-operational cutting configuration (13g) to an uncovered, cutting (unsheathed), operational cutting configuration (13h).

FIG. 7 represents the configuration where the blade portion (13b) is sheathed (13g) within the body housing (13a) and therefore is in a non-operational cutting configuration. This prevents the body of the fruit from coming into contact with the blade portion (13b). In FIGS. 7A, the blade portion (13b) is fully unsheathed (13h) and in FIG. 7B, the blade portion is partially unsheathed (13i).

However, in both the fully unsheathed and partially unsheathed situations, the blade portion (13b) is sufficiently unsheathed from within the body housing (13a), and therefore presented in a cutting configuration. However, the configuration of the arrestor means (28a) in this embodiment, ensures that only the joining point/knuckle/abscission zone of fruit cluster is small enough to fit inside this recessed notch (28a) and come into contact with the cutting edge (13e). Accordingly, even though the blade portion (13b) is exposed, this configuration also seeks to prevent or minimise the likelihood of the body of the fruit coming into contact with the blade portion (13b).

In FIG. 7C, the dimensions of the arrestor means (recessed notch cutout(28a)) are therefore important to the operation of the invention. In one example, where the invention is used to singularise clustered cherries. C1 is preferably approximately 8-12 millimetres, although in other embodiments C1 may be alternately configured within a range of between 5 and 15 millimeters, or up to at least 20 mm or more if the machine is adapted for use with other fruits (not cherries).

Also, in relation to this example, C2 is preferably approximately 2 millimetres, although again, in other embodiments, C1 may be alternately configured within a range of between 1 and 8 millimeters. When considering the dimensions at C3, this is preferably approximately 8 millimetres, although again, in other embodiments. C3 may be alternately configured within a range of between 5 and 15 millimetres. It should however, be appreciated that these dimensions relate to only some potentially realizable alternatives in relation to the singularising of clustered cherries. Therefore, these examples are not intended to limit the scope of the present invention and other embodiments may therefore be alternatively configured and have other dimensions as may be dictated by the type and size of the clustered fruit requiring singularising.

The ability of the blade portion (13b) to operate between a sheathed (13g) and an unsheathed (13h) position is facilitated by a driving mechanism (21), such as generally exampled in FIG. 6.

In the embodiment of FIG. 7 the blade portion (13b) is sheathed and, therefore, in a non-operational configuration. This is facilitated by operation of the driving mechanism (21) which effects rotation of the camshaft (21b) to position (A). The arrestor means (28) of the cutting means (13) is therefore essentially able to receive the joining point/knuckle/abscission zone of a fruit cluster.

When the blade portion (13b) is to be unsheathed and in an operational configuration (13h), this is facilitated by operation of the driving mechanism (21) which effects rotation of the camshaft (21b) to position (B), as illustrated in FIG. 7A. As such, the joining point/knuckle/abscission zone of the fruit cluster is contacted by the blade portion (13b) and the blade portion effects separation of the fruit cluster via the action of the blade portion against the joining point/knuckle/abscission zone of a fruit cluster. It should further be appreciated that, as the joining point/knuckle/abscission zone of the fruit cluster is constrained inside the arrestor means (28), it is unable to move out of the way of the blade portion, and as a result, the fruit cluster is able to be singularised/declustered whether the blade portion (13b) is sharp, or not.

In FIGS. 8-8C, a further diagrammatical series of stages in accordance with another embodiment of the present invention, again illustrate the operation of the cutting means (8) between the blade portion (13b) being fully sheathed (13g), fully unsheathed (13h) and partially sheathed (13i) as facilitated by a driving mechanism (21), such as exampled in FIG. 6.

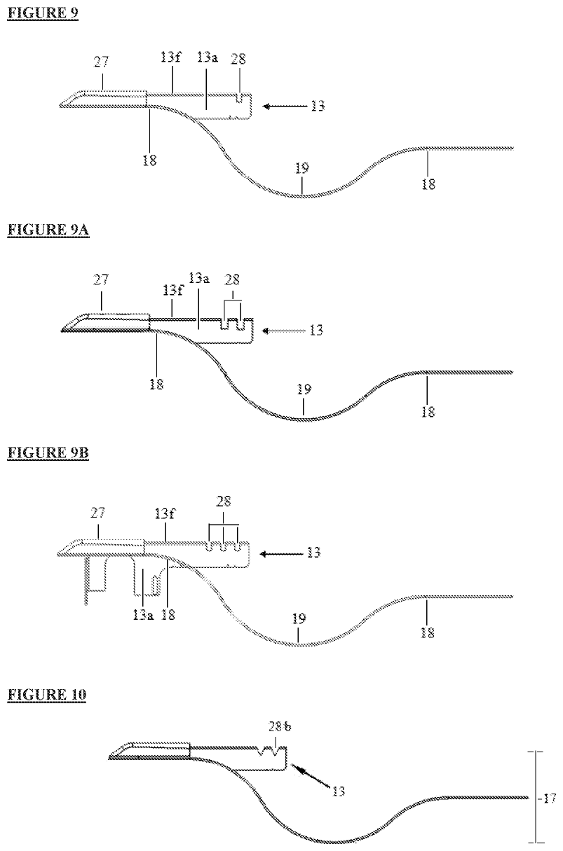

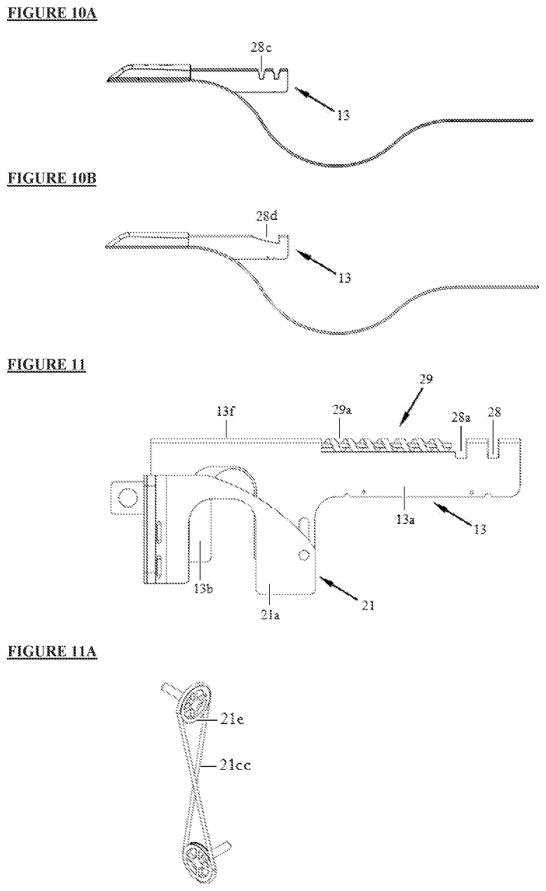

Having regard to the cutting means (13) of the present invention, FIGS. 9-10B example a range of possible embodiments of the cutting means that fall within the scope of the present invention, where the cutting means includes varying numbers of arrestor means and/or varyingly configured arrestor means.

Accordingly, multiple arrestor means (28) may be included in the housing (13a) of the cutting means (13) as illustrated in FIGS. 9-9B, which illustrate one, two or three arrestor means (28). However, it should be appreciated that these examples are not intended to limit the scope of the present invention and any number may be employed. In addition, the arrestor means (28) may be uniformly spaced apart, or may be varyingly spaced apart as desired and/or dictated by the configuration specific to each type of fruit that grows in clusters that are required to be singularised and/or by the size of the clusters requiring to be singularised and/or by the quantity of fruit that is required to be processed through the apparatus in order to singularise the clustered fruit.

In addition, FIGS. 10-10B example some possible embodiments of the cutting means (13) that fall within the scope of the present invention, wherein the arrestor means (28) may be varyingly configured (with one, two or three arrestor means illustrated at 28b, 28c, and 28d, respectively). For example, while FIGS. 9-9B illustrate single, double and triple notched arrestor means (28), the arrestor means of alternate embodiments may be triangular (FIG. 10), castellated (FIG. 10A), angled/lead-in (FIG. 10B). It should however be appreciated that these are merely some of the possible configurations available and able to be used and/or adapted for use with the present invention.

Accordingly, any suitably operational indentation or incision on the edge or surface of the housing (13a) (such as a notch (28a), groove, slot, slit), or any small protrusion extending from the housing (such as a knob, lip, slope, and so forth) may be employed. The configuration of the arrestor means (28) may therefore, be simple, or it may be more complex, depending on the clustered fruit required to be singularised.

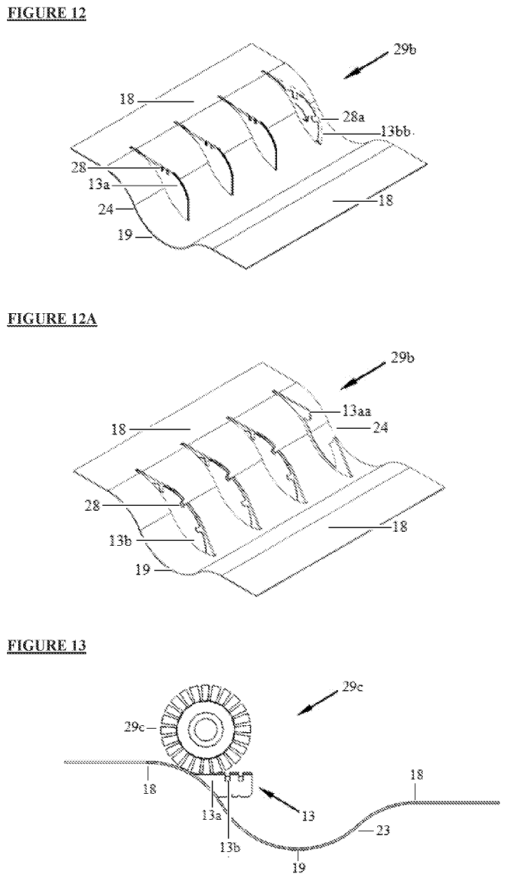

Having regard to the cutting means (13) of the present invention, FIGS. 11-18E further example a range of ‘locator’ means (29) that may be used with or adapted for use with various possible embodiments of the present invention.

The locator means (29), when included with the invention, are adapted to encourage positive directional movement of the fruit along and/or down the housing sheath (13a) of the cutter means (13) and towards the arrestor means (28) and ultimately in a preferred position to be engaged with the blade portion (13b). Some advantages of the locator means are that blockages may be prevented and throughput facilitated and/or improved.

Accordingly, an example of one embodiment of locator means (29) adapted for use with the invention is illustrated at FIG. 11. This embodiment is substantially an auger or screw based system (29a). For example, the joining point/knuckle/abscission zone of the clustered fruit may encounter with the locator means (29a) as the clustered fruit is carried along the channel and over the wave crest of an undulation where it is able to be caught by or engage with the locator means (29a).

The auger/screw locator means system (29a) may be driven via a suitably adapted driving mechanism. The driving mechanism may be separate to that responsible for operating the cutting means; or, the driving mechanism may be part of an adapted driving mechanism configured to drive both the cutter means and the locator means.

Where the driving mechanism for the auger/screw system (29a) is an adapted driving mechanism configured to drive both the cutting means (13) and the locator means (29), it is to be noted that the axis of rotation of the auger/screw means (29a) of FIG. 11 is perpendicular to that relevant to driving the cutter means (13). Therefore, consideration would be given, to the configuration and components to enable the concurrent operation of both the auger/screw system (29a) and the cutting means (13). For example, additional drive shafts and/or gearing (21e) and/or use of a series of flexible belts (21cc) that turn through 90 degrees (similar to that of FIG. 11A), and so forth, may be configured enabling both the locator means (29a) and the cutting means (13) to be driven off a common drive shaft.

Alternately, the locator means (29) may be driven by any suitable and/or adapted pneumatic or hydraulic means.

In a further embodiment of the invention, the flow of the fluid that carries the clustered fruit along the channel (8) may be used to drive the auger/screw system (29a), by diverting some of the fluid flow to the locator means mechanism. It is appreciated that the fluid flow would be required to generate enough torque on the auger and effect operation of the screw system. Accordingly, any such system devised and or so adapted may be used with the invention.

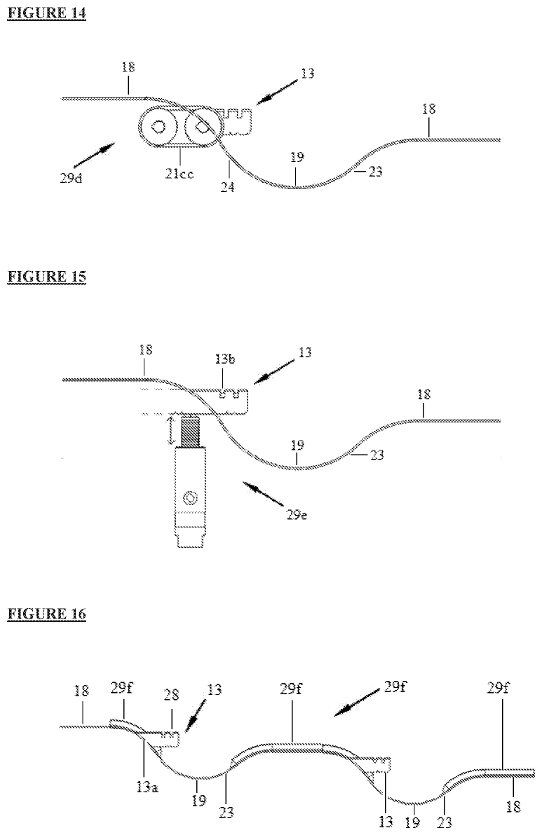

It is also to be appreciated that, having regard to variations in fruits and their clustering configurations, it may be necessary to adapt the cutting means in order to achieve the desired outcome of singularising said clustered fruits. Accordingly. FIGS. 12-18E illustrate some of alternative configurations of cutting means (13) and/or locator means (29) able to be used with, or adapted for use with the present invention. For example, FIG. 12 includes an embodiment of locator means (29b) which is configured to include a rotating cutting blade portion (13bb) of a cutting means (13). In this variation of the cutting means the reciprocating blade action is replaced with a spinning blade portion (13bb), which includes multiple arrestor means (28) as notched cutouts (28a) similar in shape to that of the reciprocating blade exampled in at least FIGS. 7-8C, but, in this embodiment, the arrestor means are spaced around the perimeter of the blade portion (13bb). This provides a similar cutting action inside the sheath but replaces the reciprocating drive system and driving mechanism (21) with a simpler, rotational, drive system. Accordingly, in this embodiment, it is the rotating blade portion (13bb) that operates as locator means (29b).

FIG. 12A presents a modified version of FIG. 12. This embodiment illustrates a rotating body/housing (13aa) of the cutting means (13). In effect, it is the sheathing feature of the body (13aa) of the cutting means (8) that is modified to rotate, and operate as the locator means (29bb). Accordingly, in this variation of the cutting means (8) the blade portion (13bb) of the cutting means remains stationary. Instead, the sheathing body (13aa) of the cutting means is comprised of two spinning discs (with a circular blade portion (13bb) located therebetween). The two spinning discs of the body (13aa) of the cutting means (13) rotate together, one on either side of the blade portion (13bb). The discs of the body (13aa) are provided with arrestor means (28) in the form of cutouts/notches (28a) which operate in the same way as the notched arrestor means of the reciprocating cutting means of at least FIGS. 7-8C.

An advantage of this embodiment is that the “moving sheath” reduces the likelihood of fruit clusters becoming stuck on the cutting means as the arrestor means (28) will effectively operate also as locator means (29bb) and will advance the stems/knuckles of the clustered fruit along the cutting means and into contact with the blade portion (13bb) of the cutting means. Accordingly, the moving sheath/body/housing (13aa) of the cutting means is able to advance the clustered fruit towards the cutting means rather than having to rely on the water flow, or on additional locator means, to do so. Accordingly, the efficiency of the process and throughput of singularised fruit may be enhanced.

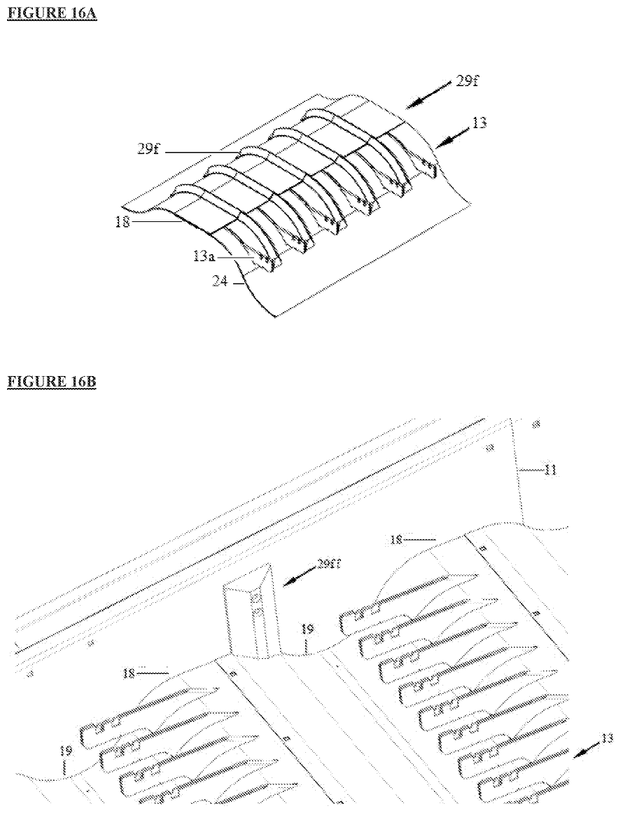

FIG. 13 illustrates yet another embodiment of the present invention in which the cutting means (13) comprises and includes an assisted means for presenting the clusters of fruit to the cutting means. For ease of reference, this version shall be referred to as a ‘brush over’ system (29c). However, the use of this term should not be seen to limit the scope of the invention.

Accordingly, in this embodiment, in addition to the standard cutting means (13) of the invention as described with reference to FIGS. 5-10B, there is included a rotating brush placed over and above the cutting means. The brush means (as illustrated by the arrow 29c in FIG. 13) in this embodiment rotates counterclockwise. The rotating brush therefore, effectively operates as a locator means (29c).

In an embodiment of the present invention which includes the ‘brush over’ system (29c), the rotational means is adapted to ensure that fruit clusters are moved along the cutting means body/sheath (13a) and into the arrestor means (28) of the cutting means (13) in order to be exposed to the blade portion (13b) of the cutting means so that the knuckle/joining point/abscission zone of the cluster is able to be cut through by the blade portion (13b) of the cutting means (13).

An additional advantage of this embodiment illustrated in FIG. 13 is, that it assists with reducing the potential for the fruit clusters to get caught and retained (stuck) on the cutting means (13). It may be appreciated therefore, that as the ‘brush over’ system operates as locator means (29c) to direct the clustered fruit towards the arrestor means (28) of the cutting means (13), this embodiment examples an additional alternate embodiment of locator means, configured and adapted for use with the invention to enhance the performance and throughput of the apparatus for singularising clustered fruit, in accordance with the present invention.

In yet other embodiments of the present invention, directional movement of the clustered fruit may be achieved, for example, through the use of a modified conveyor system (29d), including a belt or band, or a series of belts/bands.

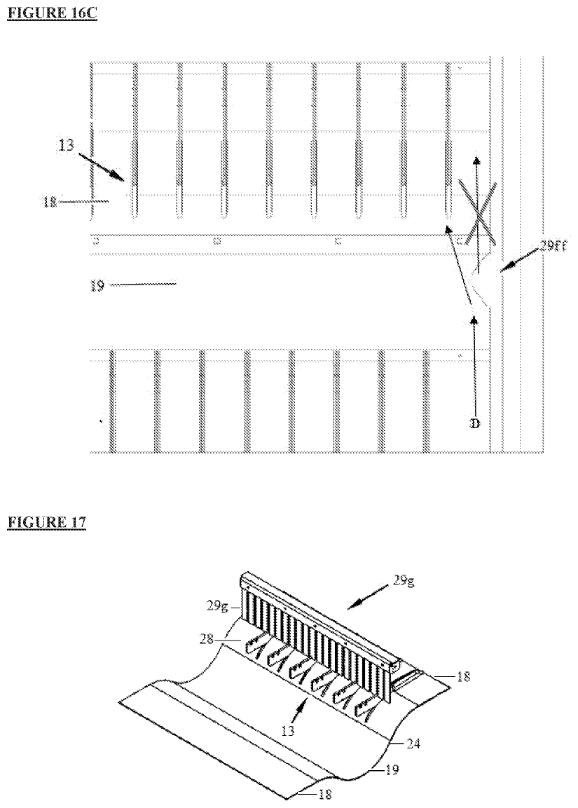

FIG. 14 illustrates one such example of potential embodiment of the present invention in which the cutting means (13) comprises and includes another assisted locator means, adapted to be used with the present invention, for presenting the clusters of fruit to the blade portion (13b) of the cutting means. Accordingly, in this embodiment, in addition to the standard cutting means and blade portion (13b) of the invention as previously described with reference to FIGS. 5-10B, there is included conveyor locator means (29d). The conveyor means in the embodiment of FIG. 14 is a continuous directionally moving band of flexible material (fabric, rubber, or metal) used in conjunction with a series of rotating drive wheels or pulleys, for transporting/transferring fruit clusters that contact the conveyor belt towards the cutting means.

The conveyor means may be configured as a round belt, a corded belt or an O-ring belt. The belt is configured to be part of the cutting means (13) and operate in line with the body of the cutting means, such that it the directional movement of the belt is towards the blade portion (13b) of cutting means. The conveyor belt locator means (29d) again functions to ensure that once the joining point/knuckle/abscission zone of a fruit cluster is caught by the belt locator means of the cutting means, this is advanced towards the arrestor means (28) and the knuckle/joining point/abscission zone of the cluster is held in place to enable the knuckle/joining point/abscission zone of the cluster to be cut through by the blade portion of the cutting means.

Again, one advantage of this alternate locator means is that it does not rely exclusively on the water pressure on the fruit body to position the knuckle/joining point/abscission zone of the cluster in an appropriate configuration relative to the blade portion (13b) for singularising the clustered fruit.

It should be appreciated that the driving mechanism used to drive the directional movement of the belt may be, or may be part of, the driving mechanism (21) used to effect operation of the cutting means (13) as previously described with reference to FIG. 6. However, any other suitable driving mechanism may be used with, or adapted for use with, this embodiment to drive the belt of this exampled embodiment of conveyor means, or other embodiments thereof.

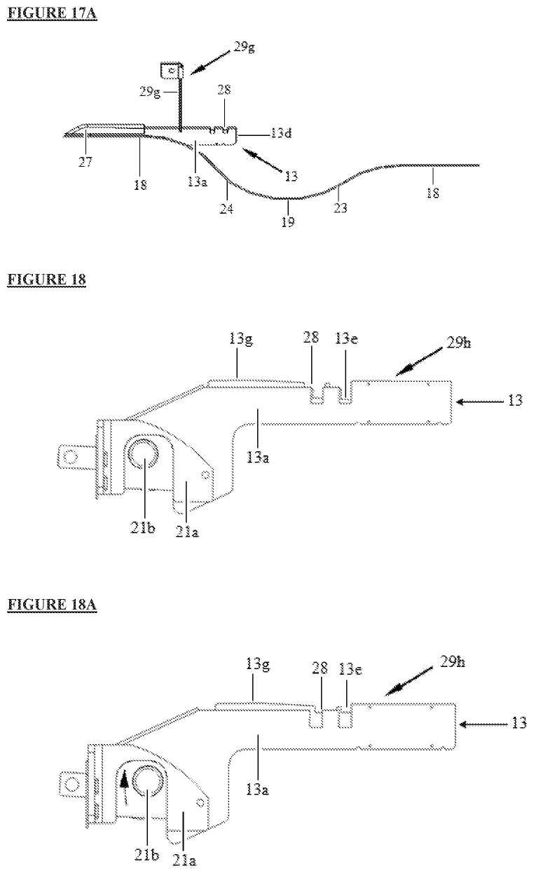

In yet another embodiment of the present invention, as illustrated in FIG. 15, the cutting means (13) may be operated by, or operated in conjunction with, locator means (29e) which are comprised of, or include, a device that uses vibratory motion to vibrate/oscillate or cause vibration/oscillation of the cutting means. Various devices are available that are designed to oscillate or shake slightly and rapidly to effect a vibratory motion or action. The device may therefore take any variable shape.

In relation to the present invention, the vibratory device may also be made/used to physically transfer said vibratory motion to the cutting means (13), such that the cutting means also vibrates. Accordingly, the vibration of the cutting means is able to effect a continuous oscillating movement that is designed to prevent fruit clusters from becoming stuck on the cutting means and help the fruit clusters travel towards the arrestor means (28) of the cutting means (13) where the knuckle/joining point/abscission zone of the cluster is held in place to enable the knuckle/joining point/abscission zone of the cluster to be cut through by the blade portion of the cutting means. In this embodiment, the vibratory locator means (29e) may effect vibrational movement that could enable the vibrations to be effected in a vertical or horizontal plane, or in a combination thereof.

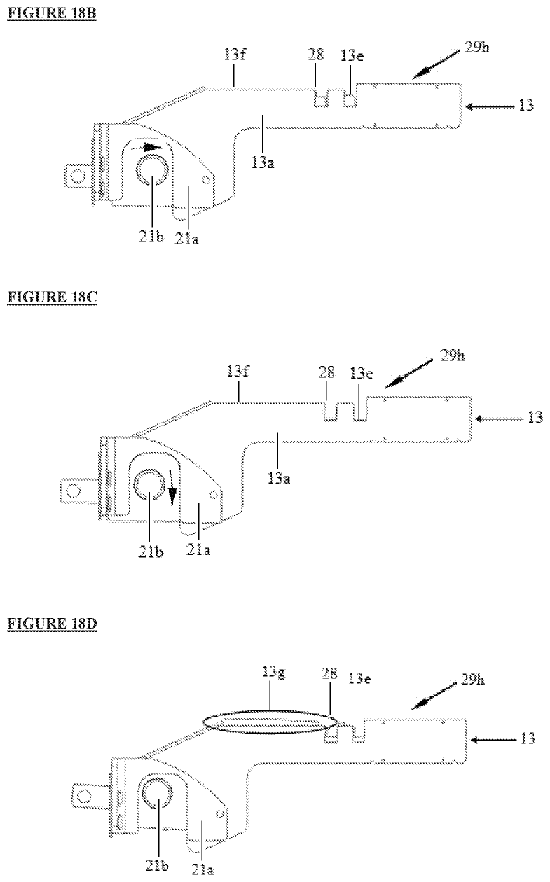

In yet other embodiments of the present invention, as illustrated in FIGS. 16-16A, the singularising/declustering apparatus may include or may be adapted to include locator means that may or do assist and/or facilitate and/or influence the direction, motion and/or positioning of the fruit clusters being transported along the channel by the fluid flow. In the embodiments of FIGS. 16-16A, such locator means, employed in this context, are exampled as diverter means (29f).

For the purpose of the present invention, the term ‘diverter’ shall mean and include any structural or operational feature of the invention which is able to divert, or is involved with diverting and/or changing the directional flow of the clustered fruit as it is transported along the channel (8) by the fluid. It should be appreciated that use of this term is not intended to limit the scope of the present invention, nor is it intended to limit the configuration and/or operation of said diverter means, nor is intended to limit the functioning of the diverter means, nor the functioning of the diverter means as locator means.

In FIGS. 16-16A the diverter locator means (29f) are associated with and across the wave crest (18) of each undulation (17) and are adapted to be and/or operate as fruit guide attachments. The diverter locator means (29f) therefore operate to increase the potential for fruit clusters, carried over the wave crest (18), to be positioned such that they contact, connect with and/or are caught by the cutting means (13). The diverter locator means (29f), operating as locator means, in turn therefore, contributes to positioning the knuckle/joining point/abscission zone of the fruit cluster in an appropriate configuration relative to the blade portion (13b) for singularising the clustered fruit.

In a working apparatus of the present invention (of which the embodiment of FIGS. 16-16A display merely a section thereof), there are multiple cutting means (13) that are arranged across and along the channel (8). As such, the diverter locator means (29f) would be preferably located along and across the channel, within the fluid stream, to facilitate contained directional flow across the wave crest (18) of each undulation (17) so that the clustered fruit are able to be directed towards the cutting means (13). However, in other embodiments the diverter locator means (29f) may alternately be located along and/or across the full length of the bed/base of the channel (8) as a whole, or in part, to direct the movement and/or the positioning of the fruit clusters throughout the length of the channel (8).

Accordingly, the diverter locator means (29f) may also be included within the wave troughs (19) following each wave crest (18) of each or some of the undulations (17), or may be only located within a portion of the wave troughs (19), following each wave crest (18). Including diverter locator means (29f) within the wave trough (19) following each wave crest (18) may assist with better aligning the fruit cluster so that should a fruit cluster miss being captured by a cutting means 13, the diverter locator means (29e) within the wave trough (18) of an undulation (17) may better direct the fruit cluster towards the next cutting means (13) associated with the next wave crest (18) of the next undulation (17).

Diverter locator means may also be included on the side walls of the channel, to send the fruit away from the walls and back in to the main fluid flow towards the located cutting means. These diverters eliminate the possibility of a fruit cluster being carried down the entire length of the machine next to the wall and not being presented to or being captured by a cutting means 13.

It is to be also appreciated, that the diverter locator means (29f) may be varyingly configured. Accordingly, they may be configured as illustrated in FIGS. 16-16A, or they may be configured as ridges within and along the length of the channel (8); or, the bed/base of the channel (8) may be configured to include ridges and/or undulations (or, other suitable configurations) not only down the length of the channel (8), but also across the width of the channel (8).

FIGS. 16B-16C generally illustrate one such alternative diverter locator means (29ff). Attached to the side wall (11) of the channel, it is adapted to extend into the channel. As the fruit clusters move along the channel, the side wall diverter (29ff) prevents the fruit clusters from being able to continue to travel along the channel adjacent to the side wall. Rather, as the fruit clusters are carried toward a wave crest (18), the fruit clusters are diverted away from the side wall (11) by the diverter locator means (29ff) and towards the cutting means (13). In the top view of FIG. 16C the arrows demonstrate how the diverter locator means (29ff) would effectively push the fruit clusters onto/towards the downstream cutting means. Having the diverter locator means (29ff) in appropriate locations along the side walls of the channel means the fruit clusters are thereby prevented from completely by-passing the cutting means (13) which could otherwise potentially be the outcome if they were simply being carried along the side wall of the channel and this, in turn, contributes to the number of uncut clusters coming out the end of the machine being significantly reduced.

It is to be also appreciated, that the diverter locator means (29ff) may also be varyingly configured. In addition, it should be appreciated that any of the diverter locator means (29f and/or 29ff) whether configured as ridges, undulations or attachments, positioned down the length and/or across the width of the channel (8), may be optionally configured to be fixed and/or stationary and/or adjustable as regards position and/or orientation, as may be required to facilitate preferred directional movement of the clustered fruit towards the cutting means (13).

One advantage of including diverter locator means (29f) and/or 29ff), within the channel of the singularising/declustering apparatus) is that, ultimately, the diverter locator means are able to greatly reduce the chance that a single fruit cluster will bypass all of the wave undulations (17) of the singularising/declustering apparatus without encountering and being captured by any of the cutting means (13) located along and across the channel (8) of the apparatus. Accordingly, said diverter locator means improve the potential to ensure that by the time the fruit clusters (inputted at the beginning of the channel) reach the outlet end (9) of the channel (8), all or most of the fruit clusters will have been singularised/separated, such that the fruit exiting the channel are single fruits, with a single intact stalk.

It should be appreciated that whilst the diverter locator means as illustrated in FIGS. 16-16C are shown as having a particular configuration, any variations in shape, size, orientation and so forth may be possible and employed to divert clustered fruit as required and also transversely/across the channel of the singularising/declustering apparatus.

It should also be appreciated that the diverter locator means may be employed either in conjunction with one or more alternatively configured locator means options or may be used as a stand-alone locator means option.

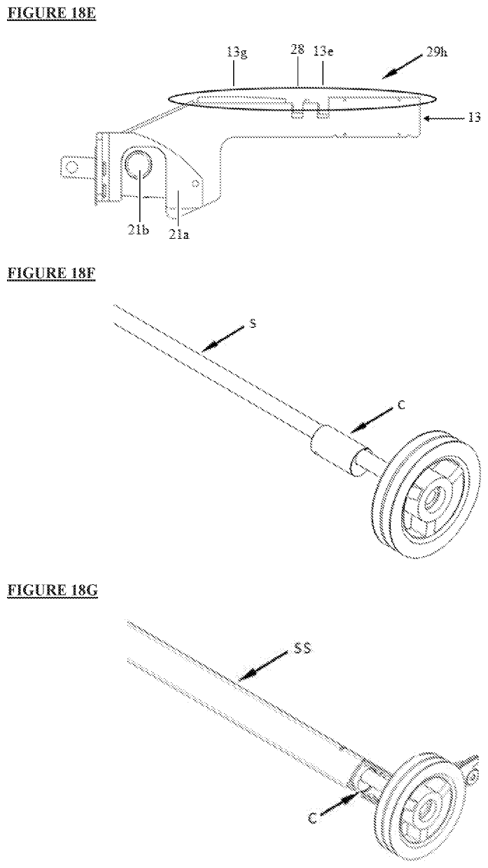

In yet another embodiment of the present invention, as illustrated in FIGS. 17 and 17A, a single wave crest (18) of an undulation (17) of the base/bed of the channel (8) is configured as a three-dimensional perspective. Associated with the wave crest (18) of the undulation (17), there are not only a number of cutting means (13) located on/in the wave crest (18) and across the width of the channel (8) (as a bank of cutting means (13)), but there is also included screening means (29g) positioned above and across the bank of cutting means (13).

For the purpose of the present invention. ‘screening’ means shall refer to and include any means that is fixed into position across the width of the channel (or any part of the width of the channel) and which is substantially upright/vertically positioned above/over the cutting means, and which is movable to the extent that it is configured to separate in order to allow clusters of fruit to pass therethrough.

Accordingly, the screening means (29g) operates as a curtain. However, use of the term ‘curtain’ should not be seen as limiting the present invention.

The curtain may be made from any suitable materials, such as the likes of bristles, fibres, rubber, thermoplastic strands, or wire that are firm enough to be able to part to allow the fruit clusters to pass through the curtain (29g), yet gentle enough not to cause damage to the individual fruits or the fruit cluster. For example, in one preferred embodiment, the curtain may be a nitrile rubber curtain.

In the embodiment illustrated by FIG. 17, the curtain (29g) is located across the width of the channel (8) over the start of the housing (13a) of the cutting means (13). The curtain (29g) is so located/designed to facilitate re-orientation of the fruit clusters as they are carried along the channel (8) within the fluid flow, such that the fruit clusters are positioned, heading towards the cutting means (13), with the stems trailing and the fruit leading. Repositioning the fruit, so that the fruit is leading as it passes over the wave crest (18) is advantageous as it contributes to enabling the fruit clusters to be preferably suspended from the cutting means (13) with the joining point/knuckle/abscission zone of the cluster being more appropriately positioned to be cut at the joining point/knuckle/abscission zone of the stems by the cutting means (13).

Accordingly, the screening means is yet another alternative embodiment of locator means, as it is configured and operates to orientate and position the fruit to better locate the fruit with reference to the cutting means (13).

One embodiment of the screen locator means (29g) is illustrated by FIG. 17 and FIG. 17B is a side view of the embodiment of FIG. 17. FIG. 17B illustrates the position of the screen locator means (29g) relative to the wave crest (18) and the cutting means (13) of the invention.

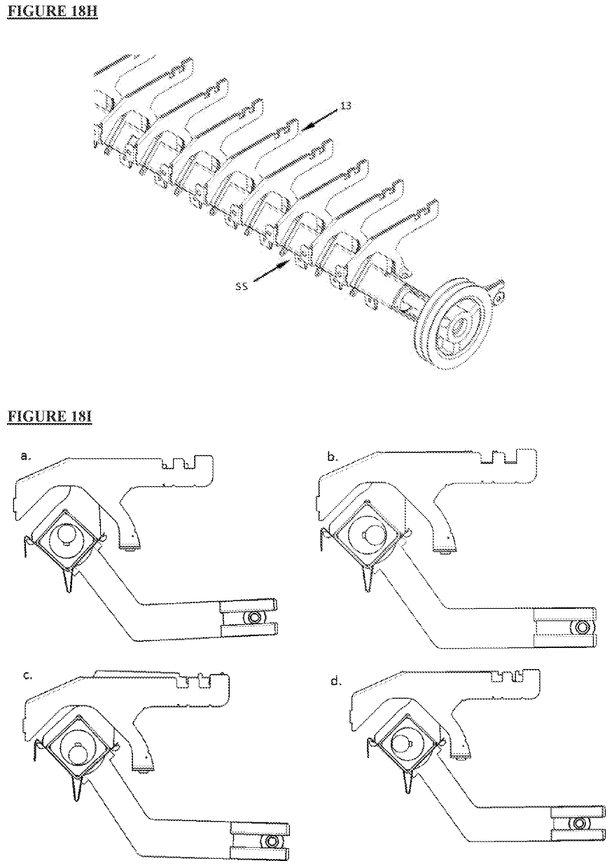

In yet other embodiments of the invention, as illustrated in FIGS. 18 to 18E, the locator means (29) for use with the invention may include modifications to the blade portion (13b). Such modifications are effectively configured to elevate and ‘walk’ the knuckle of the fruit cluster forward in an oscillating or reciprocating motion towards the blade portion (13b) of the cutting means (13). Accordingly, the embodiment as exampled by FIGS. 18-18E is a stepwise locator means (29h) in that the position of the knuckle of the fruit cluster is progressed along the cutting means (13) in a series of distinct stages.

Accordingly, in FIGS. 18-18E, the series of figures serves to illustrate a stepwise, or walking, locator means (29h). However, in this embodiment, the locator means (29h) is not external to the cutting means (13), but is rather an integral feature of, and included with, the cutting means (13).

In the figures directed to example this embodiment of locator means, the blade portion (13) itself is configured to protrude through and upwards from the housing (13a) of the cutting means (13). Accordingly, as the blade portion (13g) protrudes upward through the housing of the cutting means this protruding blade portion (13g) effects a resultant forward directional stroke which in turn operates to effectively shunt a fruit cluster along the protruding blade portion (13g) towards the blade cutting edge (13e) of the blade portion. The blade portion (13g) is then adapted to drop down within the housing (13a) of the cutting means (13). This stepwise operation serves to shunt the clustered fruit forwards and towards the arrestor means (28).

As such, the effective vertical reciprocating action of the blade portion (13g) essentially enables the blade portion itself to operate as a stepwise locator means (29h).

Accordingly, FIGS. 18-18E, diagrammatically illustrate a series of stages relevant to, and in accordance with, this additional embodiment of the present invention, which relates to a stepwise locator means (29h). These figures also illustrate the operation of the cutting means between the protruding blade portion being fully sheathed, fully unsheathed and partially sheathed as facilitated by a driving mechanism (21), as previously described in relation to FIGS. 8-8C.

The embodiments of FIGS. 18F-18I illustrate yet another, alternative, embodiment of the present invention, which relates to a stepwise locator means (29h). In relation to this embodiment, the mechanism in FIG. 18F has a rotating round shaft (S), which has some offset collars (C) mounted to it. These collars (C) generate a rotating, circular motion due to the eccentric nature of the internal hole with the external mounting face. In FIG. 18G a square shaft (SS) is mounted to the external face. Cutting means (13) and pivot arms are adapted to attach to this square shaft (SS) as shown in FIGS. 18H. The round shaft (S) has a purely rotational movement, but due to the eccentric collars (C) and the pivot arms, the square shaft (SS) moves in a circular motion with a slight wobble.

This has two additional effects in that it provides:
1. More control over the exact angle and movement of the blade through parts of the stroke, as the pivot can be moved freely.
2. More flexible sheath design as the sheath no longer has any function in generating the blade motion.

FIGS. 18I(a-d), represent firstly, the lowest position (a), then the back position (b), the highest position (c) and the forward position (d), respectively, as the mechanism moves through one revolution.

Accordingly, it should be appreciated that a range of alternative locator means (29) may be possible and may be used with, or adapted for use with, the invention and are, therefore, accordingly, included within the scope of the invention.

Accordingly, it may be appreciated that diverter means (29), may alone, or in conjunction with, arrestor means (28), provide a range of advantages. Such advantages contributing to (at least):
Positioning the fruit cluster in a preferred orientation so that, as the fruit clusters pass over the wave crest of the undulations of the channel, the fruit leads and the stem trails; and/or
Positioning the joining point/knuckle/abscission zone of the cluster so that it is better directed towards arrestor means where it may be temporarily retained/held in order that the joining point/knuckle/abscission zone of the cluster is presented for cutting; and/or
Positioning the joining point/knuckle/abscission zone of the cluster in relation to the blade portion of the cutting means, so that the blade portion of the cutting means is better able to cleanly cut through the joining point/knuckle/abscission zone of the cluster to result in singularised fruit having desired characteristics which include an intact stalk; and a stalk that is single and cleanly cut; and/or
Resulting in fruit that is not damaged; and/or
Improving the efficiency of the singularising process; and/or
Maximising the number of fruit clusters that may be subsequently deculstered/singularised as a result of a single pass through the singularising/declustering apparatus (1);
and so forth.

In some embodiments, suitably configured and operational locator means (29) alone—which employ a ‘walking effect’—may facilitate most of the above advantages.

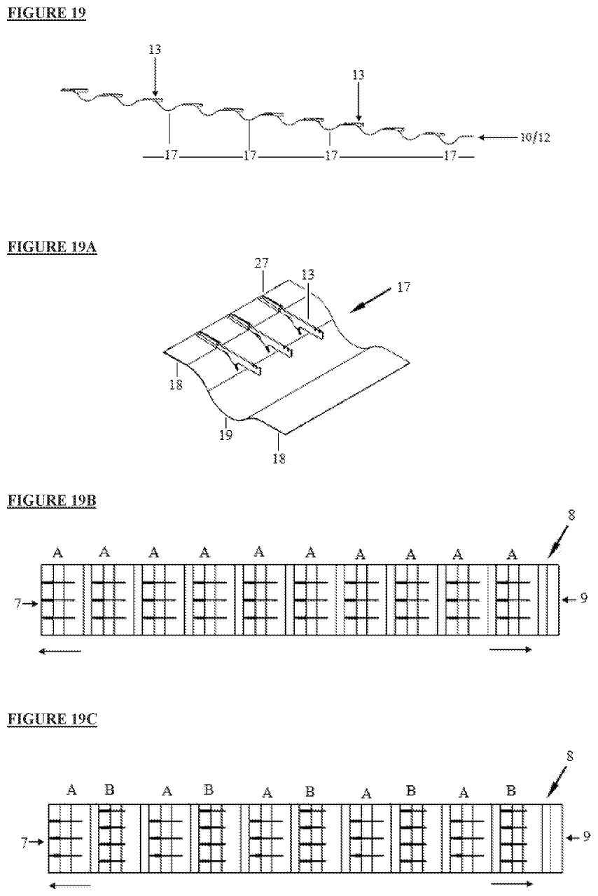

Having further regard to the singularising/declustering apparatus of the present invention, FIGS. 19-19D example a range of possible configurations of the cutting means along the channel in relation to the an undulating bed/base of the channel (8) as employed with, or adapted for use with, the present invention.

FIG. 19 is a side view of one embodiment of the channel base/bed of the invention. As can be seen, the channel base/bed is sloping. In addition, the channel bed/base includes a number of wave-like undulations (17). In this embodiment, there are ten wave-like undulations (17). However, in other embodiments where the channel is longer/shorter and/or deeper/shallower, the number of wave-like undulations may vary, accordingly.

In addition, the undulations (17) of the bed/base of the channel (8), include cutting means (13) attached to, and/or extending from or near the wave crest (18) of each undulation (17). Further, as a result of the sloping configuration of the channel base/bed, the wave crest (18) of each successive undulation (17) along the length of the channel (8) is lower than the height of the preceding wave crest (18).

Having regard to FIG. 19, FIG. 19A illustrates a top perspective view of one undulation (17) of the base/bed of the channel (8). The undulation (17) can be seen to be wave-like. As such, the undulation (17) includes a single wave crest (18) and a single wave trough (19). For the purpose of this illustrated embodiment of the undulation, the wave crest (18) is presented forward of the wave trough (19).

However, in other discussions relating to various embodiments of the present invention, it should be appreciated that the description of the wave-like undulations (17) may be described with reference to the wave trough (19) being presented forward of the wave crest (18). It should be appreciated that either description is relevant to the present invention.

Having regard to FIGS. 19 and 19A, FIGS. 19B-19D are top views exampling some possible arrangements of the cutting means (13) along and across the channel (8) in relation to an embodiment with which an undulating bed/base of the channel(8) is employed. FIGS. 19B-19D are provided as examples only and, as such, it should be appreciated that in other embodiments, the configuration of the cutting means (13) across the width and along the length of the channel (8) may vary.

In relation to the embodiment of FIG. 19B, there is illustrated a top plan view of the base/bed of a singularising/declustering apparatus (1) in which the cutting means (13) on/in the wave crest (18) of an undulation (17) are evenly spaced across the width of the channel (8), with the same arrangement of the cutting means (13) being repeated for each wave crest (18) along the length of the channel (8).

In summary, there are ten banks (undulations (17)) of three cutting means (13). For the purpose of comparing this arrangement with alternate arrangement, as shown in FIGS. 19C and 19D, the three evenly spaced cutting means (13) across each wave crest (18) of each undulation (17) shall be identified as ‘configuration A’.

When considering the top plan view of the arrangement of cutting means on/in the wave crest of an undulation in relation to FIG. 19C, the top plan view illustrates alternating banks (undulation (17)), in which each bank (undulation (17)) of three cutting means (13) (having configuration A) is followed by a bank (undulation (17)) of four substantially evenly spaced cutting means (13). Accordingly, the arrangement of four evenly spaced cutting means across each wave crest (18) of the undulation (17) shall be identified as ‘configuration B’. Therefore, FIG. 19C illustrates an arrangement of recurring Configuration A and Configuration B banks/undulations (17) along the length of the channel (8).

When further considering the top plan view of the arrangement of the cutting means (13) on/in the wave crest (18) of each undulation (17) in relation to FIG. 19D, the top plan view illustrates varying banks/undulations (17) in which each undulation (17) of the channel (8) is essentially comprised of various alternate arrangements of the cutting means (13). Accordingly, along the length of the channel (8), the configuration (location, number and spacing of the cutting means (13)) is such that, the configuration of any single bank/undulation (17) of the cutting means (13) differs in arrangement from either, or both, the undulation/bank arrangement of a preceding undulation, and/or the undulation/bank arrangement of a trailing undulation. As such (having regard to configuration A and configuration B) the top view of the channel of FIG. 19D illustrates the arrangement of the cutting means (13) across each undulation/bank (17) as being comprised of configurations (in order) of ABCDECDECD.

In this figure, the first undulation includes an arrangement of cutting means on/in and across the wave crest of the first undulation that has been designated Configuration A and the arrangement of cutting means across the width of the second undulation takes Configuration B. Thereafter, there is a repetitive arrangement of three undulations, each of which includes cutting means on/in and across the wave crest of the particular undulation where each configuration is different to Configuration A, or Configuration B and different to each other. For ease of describing and referring to each of the arrangements of the cutting means on/in and across the wave crests of these undulations, they shall be identified as being Configuration C, Configuration D and Configuration E, respectively. Further, the arrangement of cutting means on/in and across the wave crest in relation to the last two undulations of the series of undulations within the channel illustrated in FIG. 19D, are then a repeat of Configuration C and then Configuration D, respectively.

This arrangement of Configurations ABCDECDECD, as shown in FIG. 19D, is a preferred arrangement in relation to one embodiment of the present invention. However, it is to be appreciated that any arrangement of the cutting means (13) on/in and across the wave crest (18) of any undulation (17), as well as each successive undulation being the same or having a different configuration (in terms of location, number and spacing of the cutting means) when compared to the arrangement of any preceding or successive undulation, is possible.

For example, an alternative arrangement may be ABCBCBCBCB; include slightly fewer cutting means, but configure the cutting means (for example B and C) to have alternating blades as closely spaced as possible. Further, consideration may be given to the spacing between the cutting means on/in and across a wave crest. Such spacing is critical, to avoid blockages, but at the same time the more cutting means the better the machine performance. For example, a minimum distance of 60 mm (being one preferred minimum spacing) between adjacent cutting means may be selected to avoid the potential for blockages. Therefore, the spacing between cutting means on the same wave crest is quite critical. Too close together increase the potential for blockages. Too far apart the lets too much uncut fruit clusters through. Therefore, there's a balance between maintaining a certain cutting means spacing and having as many cutting means as possible.

Said further embodiments may therefore, achieve a preferred outcome in the singularising/declustering of clusters of different fruits having different configurations.

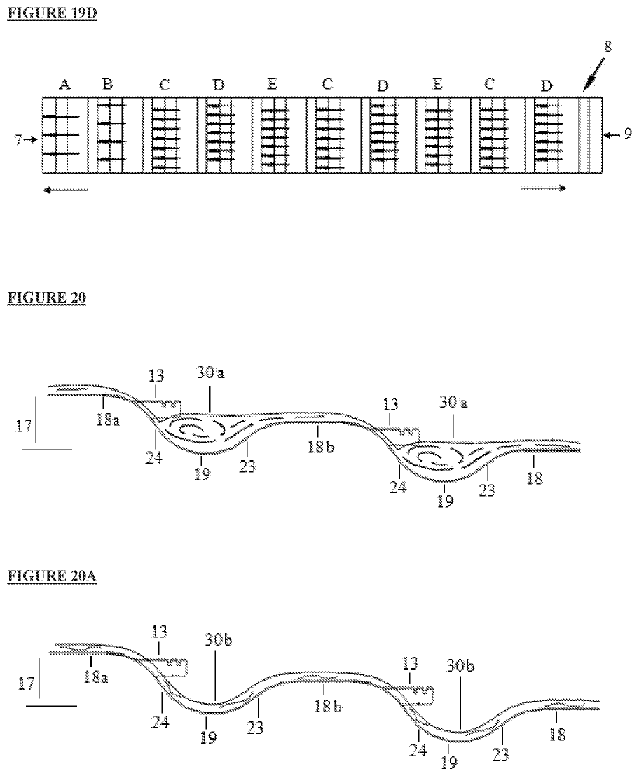

When considering the outcome of the singularising/declustering process, the flow of the fluid and hence the flow of the clustered fruit along the channel is particularly relevant. Having regard to FIGS. 20-20A the flow of the fluid along the channel is illustrated with reference to the wave crests (18) and wave troughs (19) of the base/bed of the channel (8) of the invention.

In accordance with one embodiment of the present invention, the method of singularising/declustering fruit, using declustering apparatus (1) of the present invention, requires that the fluid contained within the reservoir (4) is employed to carry/transport the clustered fruit through the declustering apparatus (1). The fluid used with the invention is water.

As may be appreciated, the fruit may be in clusters of two, to five or more, individual fruits all still joined at a single joining point/knuckle/abscission zone following the harvesting of the fruit. Therefore, the flow rate of the fluid is required to be sufficient to support the weight of the clustered fruit and transport the clustered fruit, through and along the singularising/declustering apparatus (1).

Accordingly, whilst the fluid operates as a transportation medium, the flow rate of the fluid is preferably sufficient to carry the fruit, but is not too slow. If the flow rate of the fluid is too slow, the clusters of fruit may no longer travel along the machine, but rather get stuck in the wave troughs (19). This, in turn, would mean the clustered fruit would not be declustered and/or that the fruit is less likely to be declustered.

Conversely, the flow rate of the fluid is preferably not too fast/swift, or forceful, to the extent that the pressure of the fluid causes or increases the likelihood that the fruit will become bruised/damaged during the process: or, that it causes the fruit to miss being captured by the cutting means (13) of the invention.

Preferably, a flow rate of the fluid within a range of up to or more than 10 Litres per second, for up to a 1 metre wide machine may be accommodated. A 1 metre wide machine ideally requires a recommended flow rate of 10 Us. However, it may be possible to run it with even higher flow rates where the calculations are rather based on a scaling unit per unit of width of the channel as opposed to a number at a defined width. A low flow rate may not be sufficient to carry the fruit along the channel and/or across the undulations.

Therefore, this above referenced flow rate is not to be seen as limiting the invention. Rather, the flow rate will be optimised according to the dimensions of the apparatus (1). Accordingly, a range of lower and/or higher flow rates may be required to provide the motive force to carry the fruit along and through the singularising/declustering process. For example, from a structural perspective relating to the channel (8)—such as the width of the channel—a channel width of around one metre wide could accommodate a flow rate within the range above.

Such information is helpful from the perspective of needing to accommodate and/or process ‘x’ fruit per hour, and/or as may be required to configure the channel (8) to match further in-line processes downstream, by which the width of the channel might be determined.

In addition, however, the fluid/water being pumped throughout the singularising/declustering process preferably flows at a rate and pressure that optimally orientates and/or propels the fruit through the singularising/declustering apparatus (1) and the relevant process, at a rate that optimises the singularising process, yet preferably avoids damaging the fruit. The flow rate will typically depend on and/or be dictated by the overall dimensions of the channel (8), the internal configuration of the channel and additional features configured within the channel of the singularising/declustering apparatus (1). For example, the flow rate may be determined in litres per second per metre of the singularising/declustering apparatus (1) width and/or as metres per second as measured at varying positions along the channel (8) during the processing operation.

Accordingly, the present invention requires a determination of an optimum flow rate, where the flow rate is not too slow to prevent preferred orientation of the fruit to enable successful singularising of the clusters and processing of the fruit, yet is also neither too fast to interfere with the ability of the fruit to be engaged by declustering means and/or cause damage to the fruit.

In defining the actual water flow conditions considered to be optimal in relation to at least one embodiment of the present invention, the embodiments illustrated by FIGS. 20-20A are relevant and demonstrate an important feature of the functionality of the singularising/declustering apparatus (1).

As previously described, one preferred embodiment relies on the lower placement of each subsequent wave/undulation (17), (or general downward slope), to drive the flow of water through the channel (8). The wave shape of each undulation (17) also provides the preferred location for the clusters of fruit to be fully suspended on the cutting means (13), which (as previously indicated) ensures that each cluster of fruit is able to be cut at the joining point/knuckle/abscission zone.

However, the height drop required for this suspension is much larger than that required for a reasonable speed of water flow. Accordingly, as each of the subsequent faces (forward wave slope (23)) of the next undulation (17) rises up, this effects a reduction in the speed of the fluid carried into and along the channel (8), as already mentioned.

The effect of this on the water flow depends on the relative dimensions of the drop in height between each subsequent wave/undulation (17), as well as the wave/undulation configuration (total height and length of the wave).

There are basically at least two flow regimes that are possible. These are:
1. A smooth fluid flow, much like that evident in a water slide (30b); and
2. Pool formation (30a). Here most of the wave trough (19) is filled in with a pool of recirculating water.

The preferred dimensions used in relation to the configuration of the base/bed of the channel (8) and the configurations of the undulations (17) of the channel, lead to a water flow condition typically as described at point 2 above, and as illustrated in FIG. 20. However, within the range of adjustments to the angle of slope of the channel base/bed and/or the height and widths of each undulation (17) and/or the angle of the slopes leading up to (23) and away from (24) the crest (18) of the wave of each undulation (17), the embodiment as described in point 1 above and as illustrated in FIG. 20A, is possible.

Accordingly, the speed of water and speed with which the clustered fruit travels down the channel (8) and across the wave-like undulations (17) depend on the geometry (the sizes, shapes, positions, angles and dimensions) relevant to the configuration of the channel (8) and/or the wave-like undulations (17) of the singularising/declustering apparatus (1).

Therefore, while in some embodiments pumping more water along the channel may offer some benefit, it may conversely lead to a deeper layer of fluid across the and in the channel (8), which in turn may lead to more turbulence within the channel, but not a beneficial increase in the speed of flow and/or the singularising process.

In various embodiments of the present invention, it may be preferable to achieve the least fluid/water flow possible. However, if the fluid flow is too low/too slow, the clustered fruit may not be satisfactorily ‘pulled’ or ‘propelled” out of the wave pool (30b) (as shown in FIG. 20) below the crest (designated as 18a) of the forward wave and over top of the next wave crest (designated as 18b).

To further describe this aspect of the invention, in accordance with one embodiment of the present invention, at a fluid flow rate of 5 litres per second, for a 500 mm wide machine, the fluid/water at the top/wave crest (18) of an undulation (17) is approximately 30 millimetres deep. This means that at the crest of the wave (18), the fluid is flowing at approximately 3 metres per second. In the said embodiment, this flow rate has proven to be sufficient to prevent blockages, but also be as gentle as possible (to minimise/avoid damage to the fruit).

It is also to be noted that, there may be a reduction in flow through leakages on and/or around the wave crests (18) of the undulations (17) which can reflect in less fluid and less flow available to subsequent downstream undulations (17). For this reason, the drop in the fluid depth and/or rate of flow of the fluid along the channel (8) may need to be allowed for.

Alternatively, the channel (8) may be configured to enable an injection of fluid into, or along, the channel (8), such as in the vicinity of the undulations (17), in order to maintain a preferred depth of the fluid and a preferred flow rate of the fluid along the length of the channel (8) throughout the singularising/declustering process.

It should also be appreciated that the fruit itself may not necessarily be travelling at the same speed as the fluid, as they are essentially ‘pulled up’ the forward slope (23) of the wave/undulation (17), but have to overcome friction in relation to the bottom of the channel.

In one embodiment of the present invention, where the fruit is cherries, the fruit has been timed at travelling at around 0.4 metres per second as an average speed through the channel (8) of the singularising/declustering apparatus (1). The average speed, or velocity, is defined to be the change in position divided by the time of travel. However, the speed of the fruit at any point as it travels along and through the channel (8) is of course affected by the configuration of the channel (8). Therefore, it should be appreciated that the fruit may approach a speed of around 0.8 metres per second as it travels down the trailing face (24) of a wave/undulation (17), and then potentially approaches zero metres per second, as it floats while it is within the pool (30) at the base of the wave/undulation (when it is in the trough (19) between the undulations/waves (17)), before the flow of water results in the fruit being ‘pulled up” the forward slope (23) of the next undulation/wave (17).

Wherever possible, it is preferable that the flow of fluid throughout the channel (8) be constant and smooth. For example, without the wave pool scenario (but rather the water-slide situation 30a), the water flow tends to be higher across and through the channel (8) which is not ideal for fruit handling. In situations where the water flow tends to be higher across and through the channel (8), the fruit (for example, cherries) build up momentum and travel down the trailing face (24) of the undulation (17) towards the trough (19) at a rate the same as, or close to, the speed at which the fluid is flowing—which can be much too fast. Instead, in embodiments in which wave pool (30b) creation is a feature, the wave pool (30) causes the average speed of the fruit (cherries) across the length of the channel (8) to be much slower/lower than that of the fluid, as the fruit essentially comes to a stop in each of the wave pools (30b). Secondly, the formation of the wave pool (30) means that once the clustered fruits are separated by the cutting means (13), they drop into what is effectively ‘a bath’ of water, rather than into a thin stream of water. The pools (30) therefore provide a gentle landing place for the fruit (once the clustered fruits are separated by the cutting means (13)). This again affords much gentler handling of the fruit.

For the purpose of the present invention, the wave pool (30b) formation, as described above, is referred to as a “standing wave”, as this is the effect seen as the wave pool (30b) forms in marginal conditions. It should be appreciated that the technical term for this effect is known as a “hydraulic jump”.

For the purpose of the present invention, the term ‘hydraulic jump’ refers to the open channel flow where fast moving fluid suddenly transitions to slow moving fluid, causing the water depth to rapidly rise, as well as producing turbulence. On formation, the jump can take the appearance of a wave which first travels upstream from a disturbance, and then remains stationary in place.

Accordingly, it should be appreciated that the terms ‘standing wave’ and ‘hydraulic pump’ may both be used in relation to the present invention. Therefore, neither term should be seen as limiting the scope of the present invention.

Where the angle of the bed/base is given as a reduction in height per wave of about 60 mm, then with a bank length of 400 millimetres this results in a “slope” of 8.5 degrees.

Using the ranges already provided for one embodiment of the undulation (17)/bank length and drop this provides a maximum range of slopes of between 3 degrees to 30 degrees. This range may, however, be too broad. Therefore, the range may, realistically, be more in the range of 2.5 degrees to 15 degrees.

However, it should be appreciated that this is provided with reference to one preferred embodiment of the invention. Therefore, alternative slope angles, bank lengths and wave heights may be relevant to other embodiments fall within the scope of the present invention.

It is, however, generally more relevant to consider dimensions in terms of fall per bank, rather than a general slope of the channel (8). This is because the wave profile itself has a significant effect on the water flow down the channel (8), and more so than the angle of the bed.

In addition to the above, testing has indicated that in relation to the description of the above embodiment of the invention (as described herein for the purpose of elucidating the invention), a preferred reduction in the height per wave is 45 millimetres as opposed to 60 millimetres. This would equate to a slope of 6.5 degrees. However, as may be appreciated, this is in relation to one embodiment of the invention and should, therefore, not be seen as limiting the scope of the invention to only the configurations, dimensions, units of measurement, described herein.

Having regard to other embodiments of the present invention, the potential for the fruit to be alternatively transported along and through the channel via a smooth fluid flow is also desirable. This is because such embodiments (in which the fluid flow is smooth and consistent), offer an advantage of increased capacity and throughput of clustered fruit. Therefore, such an alternative should also be seen to be included within the scope of the invention.

Further, for clarity in relation to the embodiments of the present invention, and having regard to the general description of the present invention, there may be references in which each undulation (17) is deemed to be centred on the wave peak (upstream rising, downstream falling).

However, in other embodiments (as described in the various figures) references in relation to each undulation may instead focus on the option where each wave is centred on the wave trough. It is to be appreciated that either option is encompassed within the ambit of the invention.

Having regard to other embodiments of the present invention, the potential for the fruit to be initially transported to the channel is also desirable. For example, an ‘in-feed’ lift belt (31) may be optionally included. In addition, the capacity for fruit declustering may be increased by engaging additional machines.

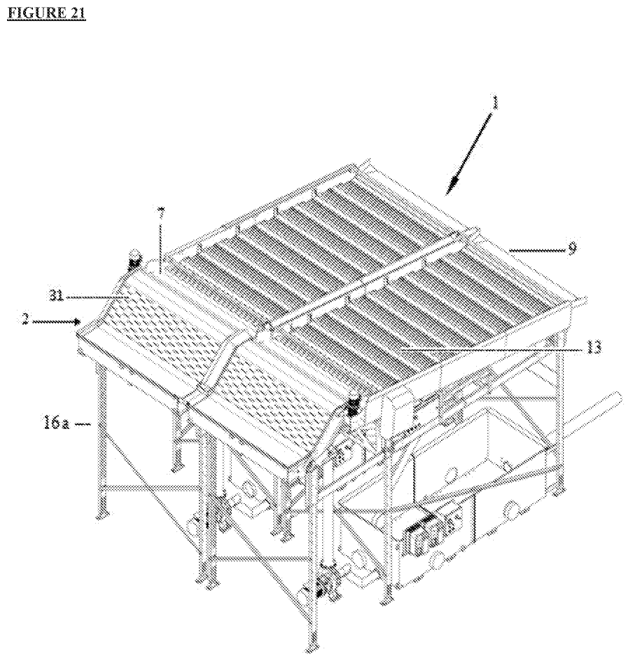

FIG. 21 illustrates an example of yet a further alternative embodiment of the present invention where the potential to increase operational capacity and efficiency is achieved by adding additional, adjacent, machines. FIG. 21 also illustrates a configuration in which the channels may be wider and shallower and includes a greater number of undulations and cutting means. FIG. 21 illustrates a dual system.

However, it should be appreciated that it is possible to simply use one machine, or, there is the ability to engage additional machines and/or offer variations in their configuration, to enable the invention to be tailored to meet specific and/or varying operational needs—such as where there is a need to decluster larger crops of fruit, or different fruits.

FIG. 21 also provides an example of a potential upstream machine configuration (2) which is represented schematically in FIG. 1, but in FIG. 21 the arrangement is exampled as a fruit-loading machine (2). This fruit-loading machine (2) includes an in-feed conveyor belt system (31) This is an optional feature designed to improve operational efficiency. Accordingly, the invention may or may not include/be used in conjunction with a system that facilitates transportation of the fruit to the channel.

However, if used, the function of the in-feed lift belt (31) may and can:
1. Help with integration into existing lines by reducing/adjusting the height drop across machine (in commercial situations where that might be desired or offer an advantage); and/or
2. Help to detangle large groups of clusters into their separate clusters. This in turn can contribute to improved performance of the machine; and/or
3. Help as a buffer to even out surges in fruit flow in to the declustering channel.

In accordance with the various features of and embodiments of the present invention, the following discussion relates to examples of potential methods of manufacture and/or construction and/or assembly of the apparatus; and, to some potential examples of the method of using the apparatus. However, these are examples only and are not to be seen as limiting the scope of the present invention.

### Example 1

A method of manufacturing/assembling the singularising/declustering apparatus in accordance with various embodiments of the present invention, is achieved by the following steps of:
a) From appropriate materials relevant to, and/or used by and/or as required to conform to standards relating to food industries, manufacture a channel:
   said channel being manufactured as a unit; and, wherein,
   said channel is manufactured from a single piece of material having the required dimensions of thickness, length and width, which is bent or moulded to form the channel shape; or, wherein, said channel is manufactured from individual portions and wherein said portions may be adapted to be optionally connected, or permanently fixed, together to form the channel having the required dimensions of thickness, length and width; and/or wherein,
   said channel is configured to include a base and two sides; and
   said channel is substantially U-shaped; and, wherein,
   said channel includes a first inlet end and a second outlet end; and, wherein,
   said base of the channel is substantially horizontal; or, wherein
   said base of the channel is substantially angled downwards; and, wherein, in one embodiment
   said base of the channel is substantially flat; or, wherein in another embodiment,
   said base of the channel is substantially contoured; and, wherein, in yet another embodiment,
   said base of the channel is configured to include undulations, and/wherein,
   said undulations are substantially wave-like; and wherein
   said wave-like undulations are substantially configured such that a wave crest is followed by a wave trough; and wherein
   said undulations being configured such that the dimensions of at least the height of each subsequent trailing wave crest is substantially lower than each preceding wave crest; and
   said sides of the channel are configured to be substantially perpendicular to the base; and, wherein,
   said channel is configured to have any one or more of a preferred length, width and/or depth, as required for the operation of the singularising/declustering apparatus; and, wherein,
   said channel includes bracing means configured and positioned along the length of the channel to strengthen the length, width and/or depth of the channel; and, wherein,
   said channel has a first, forward, inlet end and a second, trailing, outlet end; and, further wherein,
b) From appropriate materials, manufacture an optional bed component:
   said bed component being manufactured as a unit; and, wherein.
   said bed component is manufactured from a single piece of material having the required dimensions of thickness, length and width, which is bent, or moulded, to form the shape of the bed component; or, wherein,
   said bed component is manufactured from individual portions; and, wherein,
   said portions may be adapted to be optionally connected, or permanently fixed, together to form the bed component; and, further wherein.
   said bed component is adapted to be affixed to the side/side portions of the channel in a fluid-tight manner; and, wherein,
   said bed component is distanced above the base of the channel: or, wherein,
   said bed component operates as the base of the channel; and, wherein,
   said base component is substantially horizontal; or, wherein,
   said bed component is angled to slope downwards within the channel from the first, inlet end of the channel towards the second, outlet end of the channel; and, wherein,
   said bed component is substantially contoured; and, wherein.
   said bed component is configured to include undulations; and wherein,
   said undulations are substantially wave-like; and wherein
   said wave-like undulations are substantially are substantially configured such that a wave crest is followed by a wave trough; and wherein
   said undulations being configured such that the dimensions of at least the height of each subsequent trailing wave crest is substantially lower than each preceding wave crest; and,
c) From appropriate materials, manufacture cutting means:
   said cutting means including a housing and a blade portion; and, wherein,
   said housing being configured as a sheath for the blade portion; and, wherein,
   either or both the housing and the blade may be moveable; and, accordingly wherein,
   within said housing the blade portion may be stationary and the housing may be moveable; or, wherein,
   within said housing and/or along said housing the housing may be stationary and the blade portion may travel; and, wherein,
   said motion and/or directional travel of the housing and/or the blade portion may include any one or more of:
   a reciprocating, revolving, oscillating, vibrational motion; and, wherein,
   said housing of the cutting means also includes any one or more of:
   arrestor means; and,
   locator means; and, wherein.
   said cutting means is fitted into, and/or onto and/or across any one or more of the wave crests of either the base or the bed component; and, wherein.
   the number of cutting means and/or the arrangement of the cutting means may:
be uniform with respect to each undulation; or,
   vary with respect to each undulation; or,
   be specifically arranged with respect to each undulation in accordance with a preferred configuration of said cutting means; and, wherein.
   said blade portion of the cutting means is substantially elongate; and, wherein.
   said blade portion includes at least one cutting edge; and, wherein,
   said at least one cutting edge of the blade portion may be substantially blunt; or, wherein,
   said at least one cutting edge of the blade portion may be substantially sharpened; and/or, wherein,
   said at least one cutting edge of the blade portion may be substantially configured to include arrestor means; and, wherein:
d) In relation to either or both the housing and the blade portion of the cutting means with which arrestor means are employed, said arrestor means are configured to:
   temporarily stop, capture, hold and/or retain clustered fruit there over; and, wherein,
   said arrestor means is configured to facilitate the singularising of the clustered fruit; and wherein
   said arrestor means may be configured to be any indentation or incision on the edge or surface of the housing and/or the blade portion (such as a notch, groove, slot, slit), or its configuration may be a small protrusion extending from the housing and/or the blade portion; and, wherein
   said arrestor means may be singular or in multiples; and, wherein
   said arrestor means may be arranged along the length of the housing of the cutting means and/or the blade portion of the cutting means; and/or wherein,
   said arrestor means may be arranged around the diameter of the housing of the cutting means and/or the blade portion of the cutting means; and, wherein
   said arrestor means are configured such that only the knuckle/joining point/abscission zone and/or a portion of the of the fruit cluster is able to fit inside or be held against said arrestor means and thereby ensure that only the knuckle/joining point/abscission zone of the fruit cluster is able to come into contact with the blade of the cutting means; and
e) In relation to either or both the housing and the blade portion of the cutting means with which locator means are employed, said locator means are and/or may be configured to:
   operate, in part, as arrestor means; and/or
   said locator means are and/or may be configured to directionally move fruit cluster towards the location of the blade portion of the cutting means, in order to position the joining point/knuckle/abscission zone and/or the stems on to, or adjacent to, the blade portion to be severed by the blade portion; and, wherein,
   said locator means may include any one or more of, or means additional to:
   screw based systems and/or oscillating systems and/or reciprocating systems and/or conveyor systems and/or vibrating systems and/or screening systems and/or brushing systems; and, wherein,
f) In conjunction with, or separate from, the locator means there is optionally included diverter means associated within the channel, and/or across the wave crest of one or more undulations:
   said diverter means adapted to be and/or operate as fruit guide attachments to divert the clustered fruit away from the side walls of the channel and/or to assist in presenting the fruit clusters to the cutting means; and, wherein,
   said diverter means being optionally configured/attached within and/or on the length of the channel, the bed of the channel, the base of the channel; and, wherein
   said diverter means being configured as ridges, undulations, attachments, down the length and/or across the width of the channel; and, wherein
   said diverter means optionally configured to be fixed and stationary and/or adjustable as regards position and/or orientation; and, wherein
g) In conjunction with the cutting means, arrestor means, locator means and/or diverter means there is included at least one driving mechanism, wherein:
   said driving mechanism is configured to drive any one or more of the housing, blade portion, arrestor means, locator means; and wherein
   said driving includes any one or more of mechanical means, electrical means, hydraulic means, pneumatic means; and
h) From appropriate materials, construct and/or install a frame on which the channel may be positioned; and, wherein,
   said frame includes legs, said legs being optionally adjustable to facilitate height adjustment of the channel; and, wherein.
   said frame assists in stabilising the singularising/clustering apparatus relative to a surface on which the apparatus is standing and used; and
i) In conjunction with the said channel, include/attach/connect a reservoir means:
   said reservoir means being of a preferred size; and
   said size dictating the quantity of water able to be contained within the said reservoir; and, wherein,
   said reservoir includes pipes and pump means to connect with, and/or be used to circulate said water into,
   the inlet of the channel,
   through the channel; and
   from the outlet of the channel; and, wherein
   said reservoir is used alone or in conjunction with recirculating apparatus; and, wherein, either or both the reservoir means; and, wherein
   said recirculating means is optionally configured to include filtration means; and, wherein, there is further configured
j) Collection means:
   said collection means adapted to collect water spillages and/or leaks arising from the flow of the water through the channel; and, wherein
   said collection means is adapted to redirect said water to either or both the reservoir means and the recirculating apparatus.

### Example 2

A method of using one embodiment of the singularising apparatus of present invention, wherein the following steps are followed:
a) Stabilise the apparatus on/against a surface on which it is to be used, and
b) Initiate the circulation and re-circulation of the fluid through and along the channel at a preferred flow rate; and
c) Introduce the clustered fruit (required to be singularised) into the channel at the entry of the channel; and
d) allow the clustered fruit to be carried along and down the channel and be directed towards and be engaged with the cutting means, and, in embodiments where the cutting means are mechanised and/or rely on hydraulic/pneumatic/mechanical systems, engage said systems; and
e) Monitor the progress of the clustered fruit along the channel to ensure the fruit is appropriately singularised in accordance with the standards of quality desired; and
f) Allow the singularised fruit to exit the channel and progress towards any further stages (downstream/in-line); and
g) Separate clusters of fruit that have not been singularised and re-introduce the said fruit clusters into the channel at the entry of the channel.

### Example 3

In using the singularising apparatus of another embodiment of the present invention, the following steps are followed:
a) Stabilise the apparatus on/against a surface on which it is to be used; and
b) Initiate the circulation and re-circulation of the fluid through and along the channel at a preferred flow rate; and
c) Introduce the clustered fruit (required to be singularised) into the channel at the entry of the channel; and
d) Allow the clustered fruit to be carried along and down the channel and be directed towards and be engaged with the cutting means; and, in embodiments where the cutting means are mechanised and/or rely on hydraulic/pneumatic systems, engage said systems; and
e) Employ/activate either or both arrestor means and/or locator means and/or deflector means to facilitate appropriate positioning of any one of, or all of, the joint point/knuckle/abscission zone of the fruit cluster, the stem of the fruit, the fruit of the fruit clusters in order to effect the desired severing of the joint point/knuckle/abscission zone of the fruit clusters; and
e) Monitor the progress of the clustered fruit along the channel to ensure the fruit is appropriately singularised in accordance with the standards of quality desired; and
f) Allow the singularised fruit to exit the channel and progress towards any further stages (downstream/in-line); and
g) Separate clusters of fruit that have not been singularised and re-introduce the said fruit clusters into the channel at the entry of the channel.

It will accordingly, therefore, be appreciated that the various features of the invention may be varied in look, shape, dimensions, numbers, operation and so forth. For example, the size and shape of the channel and/or the configuration of the undulations and/or the base/bed configuration and/or the arrangement of the cutting means on/in the wave crest of each undulation and/or the configuration of the cutting means, along with the material from which the various features are manufactured, may be determined by the desired through put of the clustered fruit to be singularised and/or the specific fruit requiring singularising. The individual features may be dimensioned and shaped according to the purpose of the embodiment, or for aesthetic reasons. Therefore, the exampled embodiments described herein and included in the figures, are not to be seen as limiting the scope of the present invention. When referring to the description of the present invention, it should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being an authoritative disclosure of the true state of the prior art but rather as referring to considerations in and brought to the mind and attention of the inventor when developing this invention.

Aspects of the present invention have been described by way of example only and it should be appreciated that modifications, additions and variations to and from the above described embodiments may be made without deviating from the scope of the present invention

1. Declustering apparatus for singularising clustered fruit, said apparatus effecting separation of the clustered fruits from one another at the joining point/knuckle/abscission zone of the fruit cluster, said apparatus including:
at least one channel, for the linear processing of said clustered fruit; said channel adapted to facilitate directional movement of the clustered fruit and/or unclustered (singularised) fruit along the length of the channel, said channel including:
a first inlet end and a second outlet end, and
either or both a base and a bed and
side portions;
said bed configured to include undulations, and said undulations being substantially wave-like; and
cutting means, for singularising individual fruit from the said fruit cluster.

2. Declustering apparatus for singularising clustered fruit as claimed in claim 1 wherein the bed is optionally;
the base of the channel; or
separate from and distanced above the base.

3. Declustering apparatus for singularising clustered fruit as claimed in claim 2 wherein the bed or the base is optionally;
substantially horizontal; or
substantially sloping downwards from the first inlet end of the channel to the second outlet end of the channel.

4. Declustering apparatus for singularising clustered fruit as claimed in claim 3 wherein the bed or the base of the channel includes undulations configured to enable the clustered fruit and/or the unclustered fruit to progress along the channel at a preferred rate.

5. Declustering apparatus for singularising clustered fruit as claimed in claim 4 wherein the configuration of the undulations are uniform in height along the length of the bed or the base; or
substantially reduce in height along the length of the bed or the base from the first inlet end of the channel to the second outlet end of the channel.

6. Declustering apparatus for singularising clustered fruit as claimed in claim 5 wherein where the configuration of the undulations are uniform in height along the length of the bed or the base, the bed and/or the base is optionally configured to slope downwards from the first inlet end of the channel to the second outlet end of the channel to progress the clustered fruit and the unclustered fruit along the channel at a preferred rate.

7. Declustering apparatus for singularising clustered fruit as claimed in claim 5 wherein where the configuration of the undulations substantially reduce in height from the first inlet end of the channel to the second outlet end of the channel, the bed or the base is optionally configured to be substantially horizontal or to slope downwards from the first inlet end of the channel to the second outlet end of the channel as required to progress the clustered fruit and the unclustered fruit along the channel at a preferred rate.

8-11. (canceled)

12. Declustering apparatus for singularising clustered fruit as claimed in claim 1 wherein said apparatus includes a tank for retaining a fluid, said fluid providing the motive force to facilitate the travel of the clustered fruit and the unclustered fruit along the channel and across the undulations of the bed or the base from the first inlet end of the channel to the second outlet end of the channel at a preferred rate.

13. Declustering apparatus for singularising clustered fruit as claimed in claim 12 wherein the undulations of the bed or the base include cutting means, for singularising individual fruit from a fruit cluster.

14. Declustering apparatus for singularising clustered fruit as claimed in claim 13 wherein the said cutting means are located on, or within, the crest of the undulation.

15. Declustering apparatus for singularising clustered fruit as claimed in claim 14 wherein the said cutting means are located on the downstream side (trailing face) of an undulation.

16. Declustering apparatus for singularising clustered fruit as claimed in claim 15 wherein the cutting means includes a body and at least one blade portion.

17. Declustering apparatus for singularising clustered fruit as claimed in claim 16 wherein the blade portion may be fixed (unmoveable), or moveable relative to the body of the cutting means.

18. Declustering apparatus for singularising clustered fruit as claimed in claim 17 wherein the body operates as a sheath to substantially house and enclose the blade portion when the blade portion is not in an operational cutting configuration.

19. Declustering apparatus for singularising clustered fruit as claimed in claim 18 wherein the blade portion is adapted within the housing such that the blade portion may be presented from a covered (sheathed) position to an uncovered, cutting (unsheathed) position.

20. Declustering apparatus for singularising clustered fruit as claimed in claim 19 wherein either or both the body and the blade portion is configured to accommodate a driving mechanism adapted to facilitate directional movement of either or both the housing and the blade portion, to present the blade portion in the vicinity of the knuckle/joining point/abscission zone of the clustered fruit to facilitate individualisation of the fruit as the clustered fruit is transported by the water flow and carried over the crest of an undulation.

21. Declustering apparatus for singularising clustered fruit as claimed in claim 20 wherein the housing is adapted to include arrestor means to facilitate capture and temporary retention of the clustered fruit in an orientation suited to position the junction point/knuckle/abscission zone for cutting by the blade portion.

22. Declustering apparatus for singularising clustered fruit as claimed in claim 21 wherein the arrestor means is adapted to include locator means to provide directional assistance to enable the clustered fruit to be progressed towards and/or within the arrestor means and towards the blade portion of the cutting means.

23. Declustering apparatus for singularising clustered fruit as claimed in claim 22 wherein the blade portion is adapted to reciprocate (vertically or horizontally), to rotate, or to oscillate by use of any one or more of hydraulic, pneumatic, electrical or mechanical means to facilitate individualisation of the fruit at the junction point/knuckle/abscission zone of the clustered fruit.

24. (canceled)

25. A method of manufacturing and assembling declustering apparatus for singularising clustered fruit, said apparatus for effecting separation of the clustered fruits from one another at the joining point/knuckle/abscission zone of the fruit cluster, said method including:
a) from appropriate materials relevant to, and/or used by and/or as required to conform to standards relating to food industries, manufacture a channel:
wherein, said channel includes a first inlet end and a second outlet end; and, either or both a base and a bed; and wherein
said base and/or bed of the channel is configured to include substantially wave-like undulations,
such that a wave crest is followed by a wave trough; and wherein the configuration is such that the height of each subsequent trailing wave crest is substantially lower than each preceding wave crest; and
b) from appropriate materials, manufacture cutting means:
wherein said cutting means is fitted into, and/or onto and/or across any one or more of the wave crests; and
said cutting means including a housing and a blade portion; and, wherein,
said housing being configured as a sheath for the blade portion; and, wherein, either or both the housing and the blade may be moveable; said motion and/or directional travel of the housing and/or the blade portion may include any one or more of: a reciprocating, revolving, oscillating, vibrational motion; and, wherein,
said housing and/or blade portion of the cutting means also adapted as required, to include any one or more of arrestor means and locator means, configured to:
direct, temporarily stop, capture, hold and/or retain clustered fruit via the knuckle/joining point/abscission zone and/or a portion of the of the fruit cluster in a position to contact and be severed by the blade of the cutting means; and
c) optionally include diverter means associated within the channel, and/or across the wave crest of one or more undulations:
said diverter means adapted to be and/or operate as fruit guide attachments to divert the clustered fruit away from the side walls of the channel and/or to assist in presenting the fruit clusters to the cutting means; and, wherein
d) in conjunction with the cutting means, arrestor means, locator means and/or diverter means include at least one driving mechanism, wherein:
said driving mechanism also configured to drive any one or more of the housing, blade portion, arrestor means, locator means; and wherein
said driving includes any one or more of mechanical means, electrical means, hydraulic means, pneumatic means; and
e) from appropriate materials, construct and/or install a frame on which the channel may be positioned and stabilised relative to a surface on which the apparatus is standing and used; and, wherein, said frame includes legs, optionally adjustable to facilitate height adjustment of the channel; and,
f) in conjunction with the said channel, include/attach/connect a reservoir means of a size dictated by the quantity of water required; and, wherein,
said reservoir includes pipes and pump means to connect with, and/or be used to circulate said water into the inlet of the channel, through the channel and from the outlet of the channel; and, wherein said reservoir is used alone or in conjunction with recirculating apparatus; and, wherein, either or both the reservoir means and
said recirculating means are optionally configured to include filtration means; and, wherein, there is further optionally configured
g) collection means adapted to collect water spillages and/or leaks arising from the flow of the water through the channel; and, wherein said collection means is adapted to redirect said water to either or both the reservoir means and the recirculating apparatus.
